(19) United States
(12) Patent Application Publication
(10) Pub. No.: US 2013/0198118 A1
(43) Pub. Date: Aug. 1, 2013

(54) ANNOTATION OF A BIOLOGICAL SEQUENCE

(71) Applicants: Adam Kowalczyk, Glen Waverley (AU); Justin Bedo, Docklands (AU); Izhak Haviv, Caulfield (AU)

(72) Inventors: Adam Kowalczyk, Glen Waverley (AU); Justin Bedo, Docklands (AU); Izhak Haviv, Caulfield (AU)

(21) Appl. No.: 13/583,385

(22) PCT Filed: Mar. 8, 2011
(86) PCT No.: PCT/AU2011/000258

§ 371 Date: Feb. 1, 2013

(30) Foreign Application Priority Data
Mar. 8, 2010 (AU) 2010900948

(51) Int. Cl. G06N 99/00

(52) U.S. Cl. CPC G06N 99/005
USPC 706/12

(57) ABSTRACT

A computer-implemented method for annotation of a biological sequence, comprising: applying a classifier to determine a label for the first segment of a first biological sequence of a first species based on an estimated relationship between second segments in a training set and known labels of the second segments in the training set. The classifier is trained using the training set to estimate the relationship, and the second segments are of a second biological sequence of a second species that is different to, or a variant of, the first species. This disclosure also concerns a computer program and a computer system for annotation of a biological sequence.

### CROSS REFERENCE TO RELATED APPLICATIONS

The present application claims priority from Australian Provisional Application No 2010900948 filed on 8 Mar. 2010, the content of which is incorporated herein by reference. The present application is related to a corresponding international application entitled “Performance Evaluation of a Classifier”, which also claims priority from Australian Provisional Application No 2010900948. The content of the corresponding international application is incorporated herein by reference.

### TECHNICAL FIELD

This disclosure generally concerns bioinformatics and more particularly, a computer-implemented method, computer system and computer program for annotation of a biological sequence.

### BACKGROUND

A genome project generally includes two phases, the first being to assign and map sequences of the genome of a given species (or a phenotype group). The second phase, which is the annotation of the genome, assigns a role to defined portions of the genome. Genome annotation is important to transform a sequence of adenine (a), guanine (g), thymine (t) and cytosine (c) into commodities or new modalities of human health management.

Most structural annotation to date involves identification of genomic elements such as coding regions, exons, introns and open reading frames (ORFs). Less emphasis has been placed on annotation of regulatory regions, which is more difficult to achieve and could reside anywhere relative to the structural annotation listed above. Functional annotation includes attaching biological information such as biochemical function, biological function, gene expression, regulation and interactions to the genomic elements.

Recent advances in microarray technologies such as tiling arrays, single nucleotide polymorphism (SNP) arrays and, more recently, high throughput next generation sequencing (NGS) have opened the field of genome wide associations analysis (GWAS). In general terms, GWAS is an analysis of the genome of different individuals of a particular species to identify genetic associations with observable traits or disease. Such analysis puts a pressure on the development of data analysis techniques capable of coping with the large volumes of data and extracting the relevant knowledge reliably.

### SUMMARY

According to a first aspect, mere is provided a computer-implemented method for annotation of a biological sequence, comprising:
applying a classifier to determine a label for a first segment of a first biological sequence of a first species based on an estimated relationship between second segments in a training set and known labels of the second segments in the training set,
wherein the classifier is trained using the training set to estimate the relationship, and the second segments are of a second biological sequence of a second species that is different to, or a variant of, the first species.

Advantageously, the method facilitates translation of problems and solutions from one species to another, generalising beyond the apparent scope of the initial annotation. For example, the method allows a classifier trained on mouse dataset to be used for annotation of human biological sequences.

It should be understood that, in an evolutionary context, the second species may be a different species; for example, if the first species is a mouse, the second species may be a human. In a micro-evolutionary context, the second species may be a variant of the first-species; for example, an unhealthy or cancer cell that has diverged from its original germline sequence present in a healthy cell of the same individual, and is thus a variant of the first species. In this case, the divergence may exceed an acceptable threshold that would otherwise classify the second species as the same as the first.

The method may further comprise: extracting one or more features from the first segment, wherein the one or more features are also extractable from the second segments in the training set; and determining the label for the first segment based on the estimated relationship and the one or more extracted features.

The one or more features may include one or more of the following:
an occurrence frequency of a k-mer in the segment;
a position weight matrix (PWM) score histogram of the segment;
empirical data or estimation of transcription factor binding affinity of a transcription factor in the segment;
a non-linear transformation of a set or a subset of features; and
occurrence of a base pair in the segment.

The estimated relationship may be represented by a set of weights corresponding to the one or more extracted features.

In one embodiment, the first species is human and the second species is non-human, or vice versa. For example, in this case, the non-human may be mouse or yeast.

In another embodiment, the first species is a healthy cell of an organism, and the second species is a diseased cell that has diverged from its original germline sequence present in the first species, or vice versa.

In a third embodiment, the first species is a diseased tissue sample of a first patient, and the second species is a diseased tissue sample of a second patient who is distinct from the first patient in its clinical presentation, or vice versa. For example, the diseased tissue sample may be a cancer cell or tissue affected by other diseases.

The first or second biological sequence may be a genome and the first or second segments are genome segments. In this case, the label of each segment may represent whether the segment is a transcription start site (TSS).

Alternatively, the first or second biological sequence may be an RNA sequence and the first or second segments are RNA segments.

In both cases of genome and RNA segments, the label of each segment may represent one of the following:
whether the segment is a transcription factor binding site (TFBS);
a relationship between the segment and one or more epigenetic changes;
a relationship between the segment and one or more somatic mutations;
an overlap with a peak range in a reference biological sequence.
whether the segment is a 5′ untranslated region (UTR); and
whether the segment is a 3′ untranslated region (UTR).

For example, the somatic mutations may be cancer-related, such as those generated by studies by the International Cancer Genome Consortium (ICGC).

The method may further comprise: applying the classifier to determine a label for third segments, wherein the third segments are of the second biological sequence of the second species; but not in the training set.

In this case, the classifier is trained using part of a biological sequence and applied on the rest of the biological sequence of the same species. As a smaller set of segments of a biological sequence is used for training, the classifier can be trained faster and more efficiently with less processing resources. This implementation is also useful in cases where a biological sequence is only partially annotated. By training the classifier using the partially annotated sequence, the trained classifier can be used to extend the annotation to the rest of the biological sequence. In this case, the method can be used for self-consistency testing, where the classifier is trained on part of the annotated biological sequence and tested on the rest against this annotation.

The method may further comprise, prior to applying the classifier, training the classifier using the training set to estimate the relationship between the second segments and known labels of the second segments.

The estimated relationship may be determined by optimising an objective function parameterised by a set of weights and one or more features extracted from the second segments in the training set. In this case, optimising the objective function may be performed iteratively with feature elimination in each iteration until the number of features satisfies a predetermined threshold. Feature elimination may comprise ranking the extracted features based on a set of weights, and eliminating one or more of the extracted features that are associated with the smallest weight.

In one example, the classifier is a support vector machine classifier.

The method may further comprise evaluating performance of the classifier by estimating the probability of observing an equal or better precision at a given recall with random ordering of labels determined by the classifier.

In this case, the estimated probability represents the statistical significance of an observed precision at a given recall. A negative logarithmic transformation of the estimated probability will be referred to as the calibrated precision of the classifier. In this case, the larger the calibrated precision, the better is the performance of the classifier. The metric is important for a number of reasons. Firstly, the degree of linkage between the determined label and local content of the segment can be estimated. Secondly, the internal consistency of labelling and thus of the classifier can be measured. Further, calibrated precision allows an objective evaluation of different classifiers trained using different methods. Calibrated precision also provides an insight into classifiers whose performance is inadequately captured by precision-recall curves, especially when the dataset has an extremely imbalanced ratio between classes such as 1:10,000.

According to a second aspect, there is provided a computer program to implement the method according to the first aspect. The computer program may be embodied in a computer-readable medium such that when code of the computer program is executed, causes a computer system to implement the method according to the first aspect.

According to a third aspect, there is provided a computer system for annotation of a biological sequence, the system comprising:
a processing unit operable to apply a classifier determine a label for a first segment of a first biological sequence of a first species based on an estimated relationship between second segments in a training set and known labels associated with the second segments in the training set,
wherein the classifier is trained using the training set to estimate the relationship, and the second segments are of a second biological sequence of a second species that is different to, or a variant of, the first species.

### BRIEF DESCRIPTION OF DRAWINGS

Non-limiting example(s) of the method and system will now be described with reference to the accompanying drawings, in which:

FIG. 1 is a schematic diagram of an exemplary computer system for annotating biological sequences or evaluating the performance of a classifier, or both.

FIG. 2 is a flowchart of steps performed by a processing unit in the exemplary computer system in FIG. 1.

FIG. 3 is a flowchart of steps performed by a processing unit for training a classifier.

FIG. 4 is a flowchart of steps performed by a processing unit for evaluating the performance of the classifier in FIG. 1.

FIG. 5 is a series of plots illustrating various metrics against recall, where:
FIG. 5(a) is a plot of receiver operating characteristic (ROC) curves.
FIG. 5(b) is a plot of precision-recall curves (PRC).
FIG. 5(c) is a plot of precision-enrichment-recall curves (PERC).
FIG. 5(d) is a plot of enrichment-score-recall curves.

FIG. 6 is a series of charts of precision-recall curves for three test datasets of Example 1, ordered in descending order of sizes, where
Pol-II dataset in FIG. 6(a),
RefGene dataset in FIG. 6(b) and
RefGeneEx in FIG. 6(c).

FIG. 7 is a series of plots comparing six classifiers: RSV_{Po2}, RSV_{RfG}, RSV_{Ex}, ARTS_{Po2}, ARTS_{RfG} and ARTS_{Ex} of Example 1 using various metrics, where:
FIG. 7(a) is a plot of precision-recall curves (PRC),
FIG. 7(b) is a plot of calibrated-precision-recall curves (CPRC),
FIG. 7(c) is a plot of receiver operating characteristic (ROC) curves,
FIG. 7(d) is a plot of precision-enrichment-recall curves (PERC), and
FIG. 7(e) is a plot of enrichment-score-recall curves.

FIG. 8 is a series of plots comparing five classifiers RSV_{rfgH}, RSV_{cagH}, RSV_{rfgM}, RSV_{cagM} and RSV_{pol2H} of Example 2 tested on CAGE human data using various performance metrics, where:
FIG. 8(a) is a plot of precision-recall curves (PRC),
FIG. 8(b) is a plot of calibrated precision (normal log scale) against recall (CPRC),
FIG. 8(c) is a plot of receiver operating characteristic (ROC) curves,
FIG. 8(d) is a plot of precision against number of top hits, and
FIG. 8(e) a plot of calibrated precision (double log scale) against number of top hits.

FIG. 9 is a series of plots comparing five classifiers RSV_{rfgH}, RSV_{cagH}, RSV_{rfgM}, RSV_{cagM} and RSV_{pol2H} of Example 2 tested on RefGene human data using various performance metrics, where:
FIG. 9(a) is a plot of precision-recall curves (PRC),
FIG. 9(b) is a plot of calibrated precision (normal log scale) against recall (CPRC),
FIG. 9(c) is a plot of receiver operating characteristic (ROC) curves,
FIG. 9(d) is a plot of precision against number of top hits, and
FIG. 9(e) is a plot of calibrated precision (double log scale) against number of top hits.

FIG. 10 is a series of plots comparing five classifiers RSV_{rfgH}, RSV_{cagH}, RSV_{rfgM}, RSV_{cagM} and RSV_{pol2H} of Example 2 tested on CAGE mouse genome data using various performance metrics:
FIG. 10(a) is a plot of precision-recall curves (PRC),
FIG. 10(b) is a plot of calibrated precision (normal log scale) against recall (CPRC),
FIG. 10(c) is a plot of receiver operating characteristic (ROC) curves,
FIG. 10(d) is a plot of precision against number of top hits, and
FIG. 10(e) is a plot of calibrated precision (double log scale) against number of top hits.

FIG. 11 is a series of plots comparing five classifiers RSV_{rfgH}, RSV_{cagH}, RSV_{rfgM}, RSV_{cagM} and RSV_{pol2H} of Example 2 tested on RefGene mouse genome data using various performance metrics:
FIG. 11(a) is a plot of precision-recall curves (PRC),
FIG. 11(b) is a plot of calibrated precision (normal log scale) against recall (CPRC),
FIG. 11(c) is a plot of receiver operating characteristic (ROC) curves,
FIG. 11(d) is a plot of precision against the number of top hits, and
FIG. 11(e) is a plot of calibrated precision (double log scale) against number of top hits.

FIG. 12 is a series of plots comparing five classifiers RSV_{rfgH}, RSV_{cagH}, RSV_{rfgM}, RSV_{cagM} and RSV_{pol2H} of Example 3 tested on CAGE human data using various performance metrics, where:
FIG. 12(a) is a plot of precision against number of top hits, and
FIG. 12(b) a plot of calibrated precision (double log scale) against number of top hits.

FIG. 13 is a series of plot comparing four classifiers trained on MergedCellLine cMycH, cMycM, cMycH Helas3 Cmyc and cMycH K562 CmycV2 datasets of Example 4 and tested on MergedCellLine cMycH dataset using various performance metrics, where:
FIG. 13(a) is a plot of precision-recall curves (PRC),
FIG. 13(b) is a plot of calibrated precision (normal log scale) against recall,
FIG. 13(c) is a plot of receiver operating characteristic (ROC) curves,
FIG. 13(d) is a plot of precision against the number of top hits, and
FIG. 13(e) is a plot of calibrated precision (double log scale) against number of top hits.

FIG. 14 is a series of plot comparing four classifiers trained on MergedCellLine cMycH, cMycM, cMycH Helas3 Cmyc and cMycH K562 CmycV2 datasets of Example 4 and tested on cMycM dataset using various performance metrics, where:
FIG. 14(a) is a plot of precision-recall curves (PRC),
FIG. 14(b) is a plot of calibrated precision (normal log scale) against recall,
FIG. 14(c) is a plot of receiver operating characteristic (ROC) curves,
FIG. 14(d) is a plot of precision against the number of top hits, and
FIG. 14(e) is a plot of calibrated precision (double log scale) against number of top hits.

### DETAILED DESCRIPTION

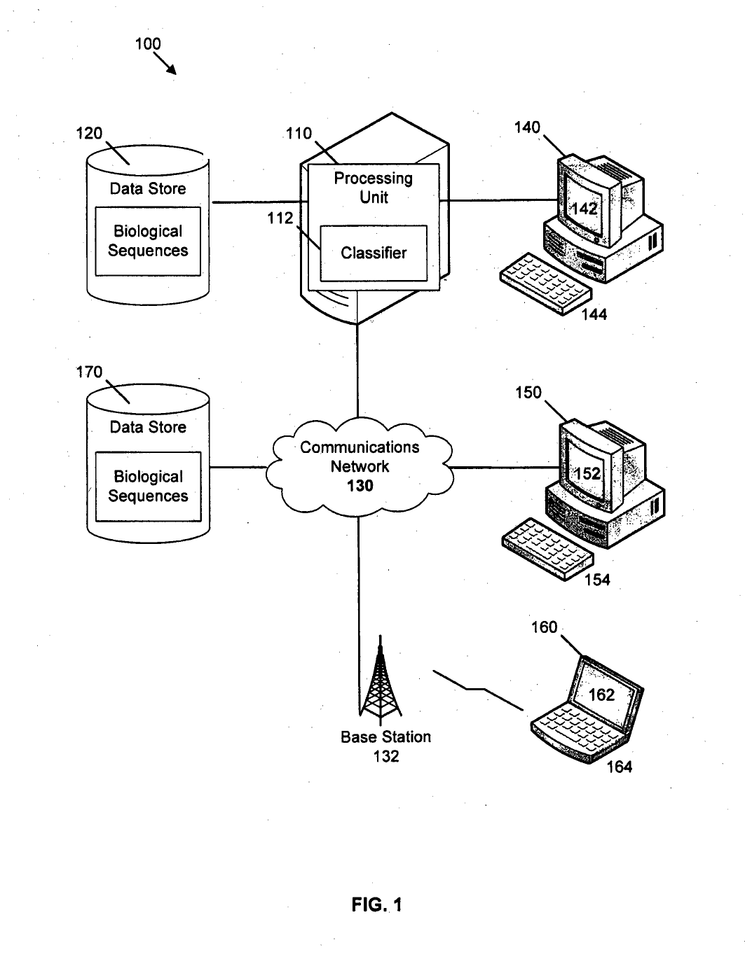

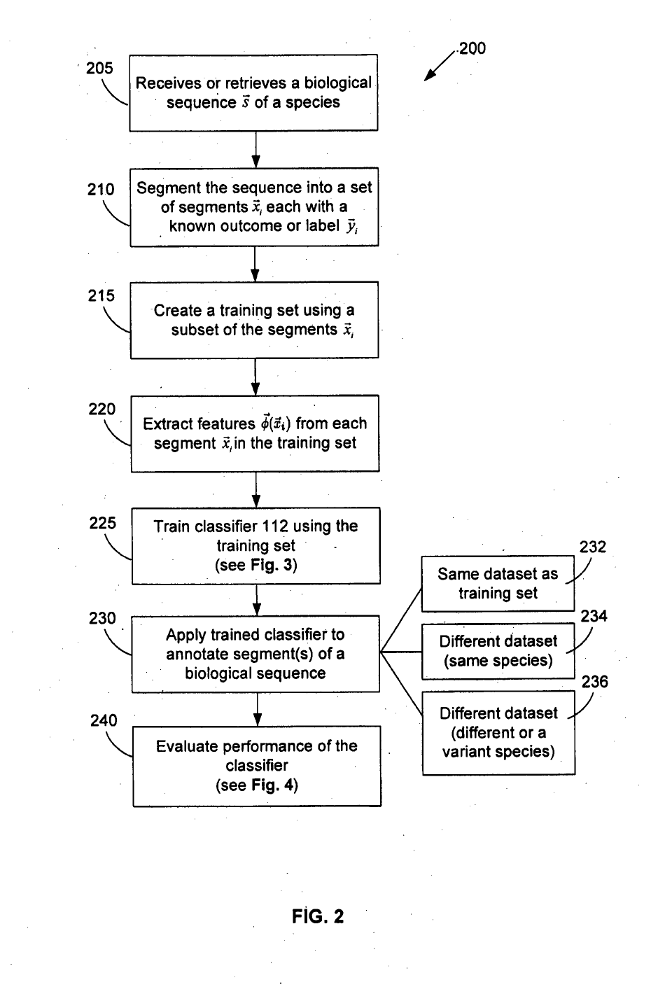

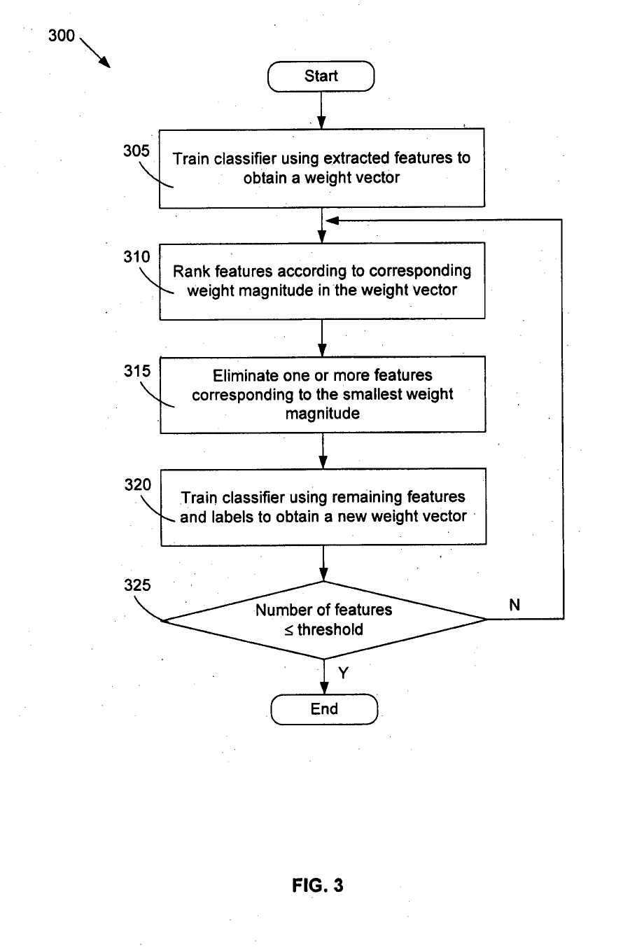

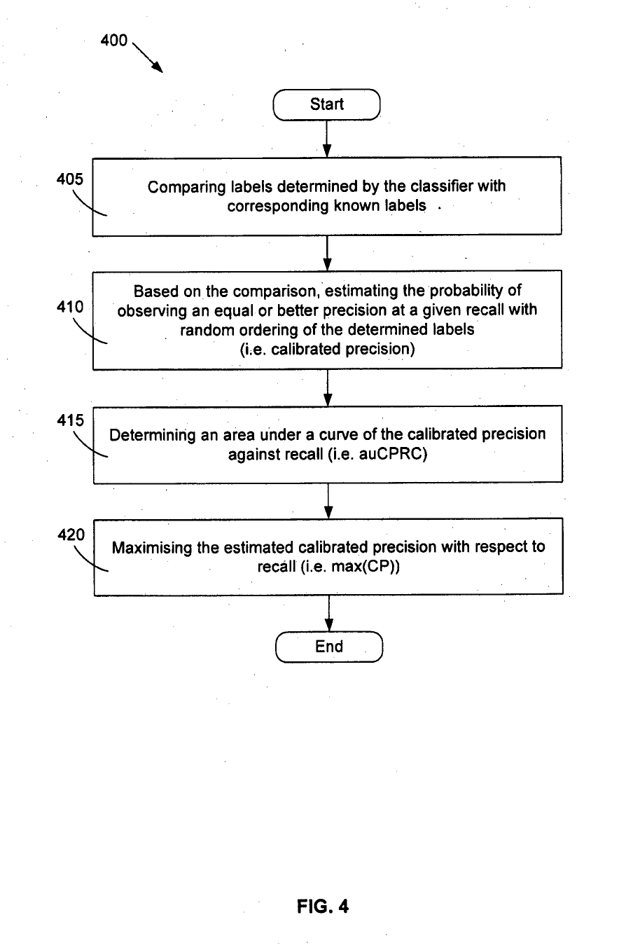

Referring first to FIG. 1, a computer system 100 comprises a processing unit 110 and a local data store 120. The processing unit 110 is operable to perform a method for annotation of a biological sequence using a classifier 112; see FIG. 2 and FIG. 3. Alternatively or additionally, the processing unit 110 is also operable to perform a method for evaluating performance of the classifier 112; see FIG. 4. The “classifier” 112 should be understood as any system capable of performing classification or prediction, which is exemplified in the context of annotation of a biological sequence in this disclosure.

A local computing device 140 controlled by a user (not shown for simplicity) can be used to operate the processing unit 110. The local computing device 140 is capable of receiving input data from a data entry device 144, and displaying output data using a display screen 142. Alternatively or in addition, the method can be offered as a web-based tool accessible by remote computing devices 150, 160 each having a display screen 152, 162 and data entry device 154, 164. In this case, the remote computing devices 150, 160 are capable of exchanging data with the processing unit 110 via a wide area communications network 130 such as the Internet and where applicable, a wireless communications network comprising a wireless base station 132. Referring first to FIG. 2, the processing unit 110 first retrieves or receives a biological sequence \vec{s} in the form of a DNA sequence from a dataset for annotation in step 205:
\vec{s}ε{a,g,t,c}ⁿ,
   where n is the length of the sequence and each nucleotide in the sequence is either adenine (a), guanine (g), thymine (t) or cytosine (c). In this example, the biological sequence \vec{s} relates to a “genome”, a term which is understood in the art to represent hereditary information present in an organism.

The sequence may be retrieved from the local 120 or remote 170 data store, or received from a local computing device 140 or a remote computing device 150, 160 via the communications network 130. In this case, the remote data store 170 may be a genetic sequence database such as GenBank with an annotated collection of DNA nucleotide sequences.

### Segmentation

The processing unit 110 then divides the sequence \vec{s} into multiple potentially overlapping segments or tiles; see step 210. Each segment \vec{x}ᵢ comprises some the nucleotides in the sequence \vec{s}:
\vec{x}ᵢε{a,c,g,t}^{w}
   where \vec{x}ᵢ is the ith segment, w<n is the window size or length of the segment and each nucleotide in the sequence is either adenine (a), guanine (g), thymine (t) or cytosine (c).

The overlapping segments \vec{x}ᵢ may be of window size w=500 bp (base pairs) are used, shifted every 250 bp; see Examples 1 and 2 and FIG. 6 to FIG. 11. In another example, the window size may be smaller, such as w=50 bp (base pairs) and shifted every 25 bp; see Example 3. In this case, each nucleotide is covered by exactly two segments. Overlapping segments are used to mitigate the effect of edges. For each nucleotide, the 250 bp neighbourhood centred around the nucleotide is fully contained in exactly one 500 bp segment.

Each segment \vec{x}ᵢ is associated with a known binary label yᵢ=±1. The binary label yᵢ represents a known outcome or classification of the segment \vec{x}ᵢ. The (\vec{x}ᵢ, yᵢ) pairs form a training dataset for training the classifier 112 that labels each segment \vec{x}ᵢ into one of two classes: +1 or −1. Although two classes are considered here, it should be appreciated that there may be more than two classes of known labels in other applications.

Depending on the applications, the label yᵢ may be whether the segment \vec{x}ᵢ is a transcription start site (TSS) to predict the location of genes which encode proteins in a genome segment.

In other applications, the label yᵢ may represent one of the following:
whether the segment \vec{x}ᵢ is a transcription factor binding site (TFBS);
a relationship between the segment \vec{x}ᵢ and one or more epigenetic changes;
a relationship between the segment \vec{x}ᵢ and one or more somatic mutations;
an overlap with a peak range in a reference biological sequence.
whether the segment \vec{x}ᵢ is a 5′ untranslated region (UTR); and
whether the segment \vec{x}ᵢ is a 3′ untranslated region (UTR).

### Training Set

The volume of datasets available for the whole genome analysis is generally very large. For example in Table 1, the Pol II and RefGene datasets contain 10.72 M different segments each, while the RefGeneEx dataset contains only 0.96 M segments. Training using the whole dataset is therefore a resource-intensive and expensive exercise.

To cope with large volume of data, the processing unit 110 then forms a training set using only a subset of the segments \vec{x}ᵢ; see step 215. In the example above, in the case of training on the reduced dataset RefGeneEx of 0.96M segments, only 13 K segments were actually used during training. Testing, as will be explained further below, is performed on the whole datasets available, including Pol II and RefGene with 11 M segments each.

### Feature Extraction,

The processing unit 110 then extracts one or more features from each segment \vec{x}ᵢ in the training set; see step 220 in FIG. 2. In one embodiment, the features extracted from the segment \vec{x}ᵢ; are k-mers frequencies, which are the occurrence frequencies or frequency counts of all sub-sequences of length k<<w (Bedo et al., 2009; Kowalczyk et al., 2010). The feature vector \vec{φ}(\vec{x}ᵢ) is a map between sequences in the segment \vec{x}ᵢ and the k-mer feature space.

For some classification tasks that are not strand specific, the frequencies for forward and reverse complement pairs are summed together. For modeling strand specific phenomena, the compression of forward and reverse complements can be omitted. If k=4 is used for classification and learning, and for notational convenience a constant feature of value 1 is added, the feature vector:

\vec{φ}(\vec{x}ᵢ)ε [symbol] ¹³⁷

maps each segment \vec{x}ᵢ, into a

$$\frac{1}{2} ( {4}^{k} + {4}^{\frac{k}{2}} ) + 1 = 137 - dimensional space .$$

In the following examples, k=4 is chosen based on some initial experimentation with different values of k in (Bedo et al., 2009). However, it should be understood that other values of k may be more suitable for different applications. In should also be understood that, additionally or alternatively, other types features may be used, such as a position weight matrix (PWM) score histogram of the segment; empirical data or estimation of transcription factor binding affinity of a transcription factor in the segment; a non-linear transformation of a set or a subset of features and occurrence of a base pair such as c-g in the segment.

### Supervised Learning Using Training Set

As shown in step 220 in FIG. 2, the processing unit 110 trains the classifier 112 using the training set to estimate a relationship between each segment \vec{x}ᵢ in the training set and known binary labels y̅ᵢ associated with the segments.

In this example, the classifier 112 is in the form of a support vector machine (SVM) and the relationship is represented using a set of weights in a weight vector \vec{β}. The classifier 112 is defined by a linear prediction function:

f(\vec{x}ᵢ):= [symbol] \vec{φ}(\vec{x}ᵢ),\vec{β}

[symbol]

where \vec{x}ᵢ is the ith segment, \vec{φ}\vec{x}ᵢ) is a feature vector and \vec{β}ε [symbol] ¹³⁷ is a weight or coefficient vector with weights corresponding to each feature in the feature vector. The classifier 112 is also associated with an objective function Ξ(\vec{β}), which the processing unit 110 minimises to compute weight vector \vec{β}=[βᵢ]:

$$\vec{β} := arg {min}_{\vec{β}} Ξ ( \vec{β} ) , \\ Ξ ( \vec{β} ) := \frac{1}{2} {\sum }_{i} {max ( 0 , 1 - {y}_{i} 〈 \vec{φ} ( {\vec{x}}_{i} ) , \vec{β} 〉 )}^{2} + \frac{1}{2} λ {‖ \vec{β} ‖}^{2} ,$$

where λ is the regularisation hyperparameter.

Let X denote a matrix where the ith row is the sample \vec{φ}\vec{x}ᵢ) in feature space and \vec{y}denotes the vector [yᵢ], then we can write Ξ in matrix form as

$$Ξ ( \vec{β} ) = \frac{1}{2} {( X \vec{β} - \vec{y} )}^{T} I ( X \vec{β} - \vec{y} ) + \frac{1}{2} λ {‖ \vec{β} ‖}^{2} ,$$

where I=I(\vec{β}) is a diagonal matrix with entries:

Iᵢᵢ=[1−yᵢ [symbol] \vec{φ}(\vec{x}ᵢ),\vec{β} [symbol] ≧0]

and [•] denotes the Iverson bracket (indicator function).

Minimisation of objective function Ξ(\vec{β}) can be done for small k in the primal domain. This comprises of iterating weights:

\vec{β}ₜ₊₁←(X^{T}IₜX\vec{β}ₜ+Λ)⁻¹X^{T}IₜY,

where Λ is a diagonal matrix with entries Λᵢᵢ:=λ. This is a variant of the well-known ridge-regression solution (Hastie et al., 2001) with the additional Iₜ:=·I(\vec{β}ₜ) matrix. It effectively implements a descent along the subgradient of E. For large k, Ξ can still be minimised using a large-scale SVM learning algorithm such as the Pegasos algorithm (Shalev-Shwartz et al., 2007).

To reduce the number of features used in the model, the processing unit 110 uses a recursive support vector (RSV) method where the SVM is combined with recursive feature elimination (Guyon et al., 2002). Referring also to FIG. 3, the processing unit 110 calculates weight vector for each segment \vec{x}ᵢ and ranks features \vec{φ}(\vec{x}ᵢ) according to their corresponding calculated weights; see steps 305 and 310. One or more features \vec{φ}(\vec{x}ᵢ) with the smallest magnitude |βᵢ| are then eliminated; see step 315. In one example, a feature is “eliminated” or disregarded by setting its corresponding weight to zero.

To accelerate the process, 10% of the worst features were discarded when the model size was above 100 features and individually discarded when below. To optimise the model size and regularisation parameter λ, the 3-fold cross-validation on the training data (Hastie et al., 2001) was used with a grid search for λ, and the model with greatest average area under precision recall curve, auPRC chosen.

This process is then repeated recursively until a classifier 112 with a desired number of features is obtained; see steps 320 and 325. The trained classifier 112 will be referred to as a “RSV classifier” or trained model in the rest of the specification. However, it will be appreciated that the classifier 112 does not have to be a SVM or RSV classifier and any other suitable classifiers can be used.

For example, Naive Bayes (NB) algorithm and Centroid algorithm (Bedo, J., Sanderson, C. and Kowalczyk, A., 2006) may be used. Unlike the “RSV classifier”, these algorithms do not require any iterative procedure to create their predictive models. Accordingly, their development is rapid, and in the current setting when the number training examples exceeds significantly the number of features, they may be robust alternatives to the “RSV classifier”. The NB algorithm makes an assumption that all measurements represent independent variables and estimates the probability of the class given evidence using the product of frequencies of variables in classes in the training data. On the other hand, the centroid classifier builds a 2-class discrimination model by weighting each variable by a difference of its means in both classes (or phenotypes).

### Application

The processing unit 110 then applies the trained classifier 112 to annotate or determine a label for segments that are not in the training set; see step 230 in FIG. 2. The trained classifier 112 can also be used to annotate other sequences, including sequences from other species.

More specifically, the trained classifier 112 can be applied on the following:
Segments within the same biological sequence or dataset, but not in the training set; see 232. This is a form of self-consistency test where a dataset is tested against itself.
Segments within a different biological sequence or dataset, but of the same species as that of the training set; see 234.
Segments within a different biological sequence or dataset and of a (first) species different to, or a variant of, the (second) species of the training set; see 236. This is known as cross-species annotation transfer.

It should be understood that, in an evolutionary context, the second species of the training set may be a different species. The first species may be human and the second species (training set) non-human, or vice versa. For example, a classifier trained using mouse tags can be tested using human tags to assess its performance on the latter. This allows translation of problems and solutions from one organism to another and better use of model organism for research or treatment of human conditions.

In a micro-evolutionary context, the second species may be a variant of the first species. For example, the first species is a healthy cell of an organism, and the second species may be an unhealthy or cancer cell that has diverged from its original germline sequence present in the first species, and is thus a variant of the first species. In this case, the divergence may exceed an acceptable threshold that would otherwise classify the second species as the same as the first. The first species may also be a diseased tissue sample of a first patient, and the second species is a diseased tissue sample of a second patient who is distinct from the first patient in its clinical presentation.

### Performance Evaluation

The processing unit 110 is operable to evaluate the performance of the classifier 112; see step 240 in FIG. 2.

Consider a predictive model (hypothesis) f: [symbol] → [symbol] . As the decision threshold θε [symbol] is varied, we denote:

nᵣ⁺=nᵣ⁺(θ):=|{\vec{x}ᵢ|f(\vec{x}ᵢ)≧θ&yᵢ=+1}|, (1)

nᵣ⁻=nᵣ⁻(θ):=|{\vec{x}ᵢ|f(\vec{x}ᵢ)≧θ&yᵢ=−1}|, (1)

where nᵣ⁺ is the number of true positive labels and nᵣ⁻ is the number of false positive (i.e. negative) labels or examples recalled with scores not less than the threshold θ. In other words, true positive labels are positive labels that are correctly determined by the classifier 112 and have a corresponding known positive label. Also, false positive labels are positive labels that are incorrectly determined by the classifier 112 and have a corresponding known negative label.

Referring also to the flowchart in FIG. 4, the processing unit 110 first compares outputs or labels f(\vec{x}ᵢ) determined by the classifier 112 for multiple segments \vec{x}ᵢ of a biological sequence with corresponding known labels y̅ᵢ; see step 405. For a particular dataset of multiple segments, the processing unit 110 calculates nᵣ⁺ and nᵣ⁻ by comparing the output of, or label determined by, the classifier 112 f(\vec{x}ᵢ) and known binary label y̅ᵢ, for all segments \vec{x}ᵢ, and tabulating the number of positive (nᵣ⁺) and negative (nᵣ⁻) examples recalled according to Eq. (1) and Eg. (2). The output of the classifier 112 f(\vec{x}ᵢ) may be a continuous or discrete value.

The performance of the classifier 112 can then be evaluated by calculating the following metrics: calibrated precision in step 410, area under a calibrated precision-recall curve (auCPRC) in step 415 and maximum calibrated precision in step 420 in FIG. 4. Although the calculation of these metrics is exemplified using the classifier 112 for annotation of a sequence, it should be appreciated the method for evaluating performance can be applied to other types of classifiers.

### Definition 1: Recall

The recall metric ρ(θ) is defined as the sensitivity or true positive rate (TPR):

ρ(θ)=sen(θ)=TPR(θ):=nᵣ⁺/n⁺ (3)

where nᵣ⁺ is the number of true positive examples, n⁺ is the total number of positive examples. Recall ρ(θ) provides a measure of completeness as a ratio between the number of true positive examples “recalled” and the total number of examples that are actually positive examples. In other words, recall is a ratio between a number of correctly determined positive labels (n) and a total number of positive known labels (n⁺).

### Definition 2: Precision

The precision metric ρ(θ) is defined as:

$$p ( θ ) := \frac{{n}_{r}^{+}}{{n}_{r}^{+} + {n}_{r}^{-}} = \frac{{n}_{r}^{+}}{{n}_{r}} , \qquad ( 4 )$$

where nᵣ⁺ is the number of true positive examples and n^{r}:=nᵣ⁺+nᵣ⁻ is the total number of true positive and negative examples. Precision p generally provides a measure of exactness. In other words, precision is a ratio between a number of correctly determined positive labels (nᵣ⁺) and a total number of (correctly or incorrectly) determined positive labels (nᵣ:=nᵣ⁺+nᵣ⁻).

### Definition 3: Area Under PRC

The area under PRC (auPRC) is the area under a plot of precision ρ(θ) versus recall ρ(θ). The plot is known as the precision-recall curve (PR curve or PRC) and auPRC is used as a general measure of the performance across all thresholds in Sonnenburg et al., 2006 and Abeel et al., 2009.

### Definition 4: ROC

The receiver operating characteristic (ROC) curve is the plot of the specificity versus the recall (or sensitivity or true positive rate). Specificity spec(θ) is defined as:

spec(θ)=1−FPR(θ):=1−nᵣ⁻/nᵣ⁻ (5)

where FPR(θ) is the false positive rate obtained by dividing the total number of negative recalled examples nᵣ⁻ with the total number of negative examples n⁻.

### Definition 5: Area Under ROC

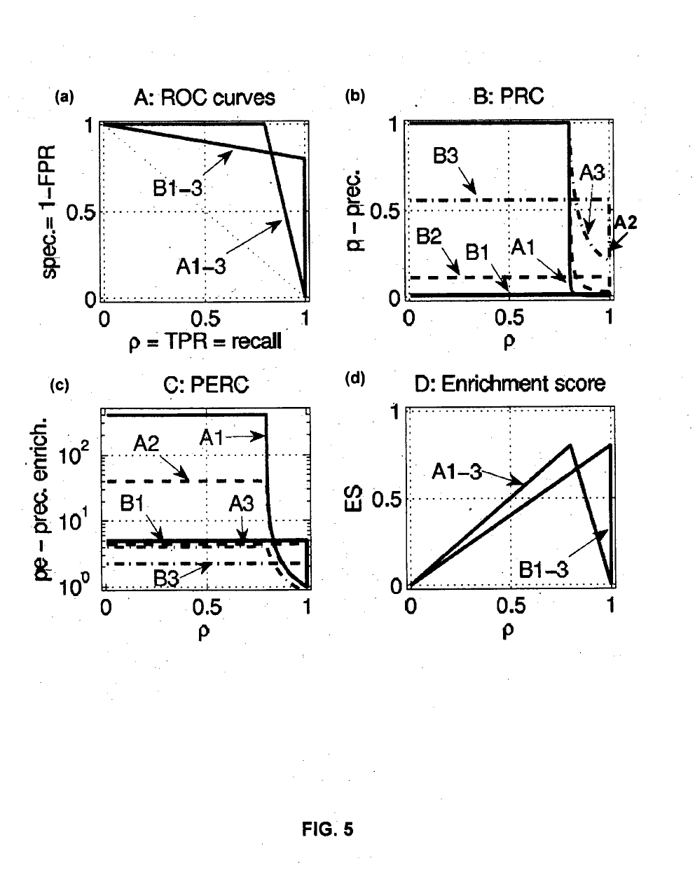

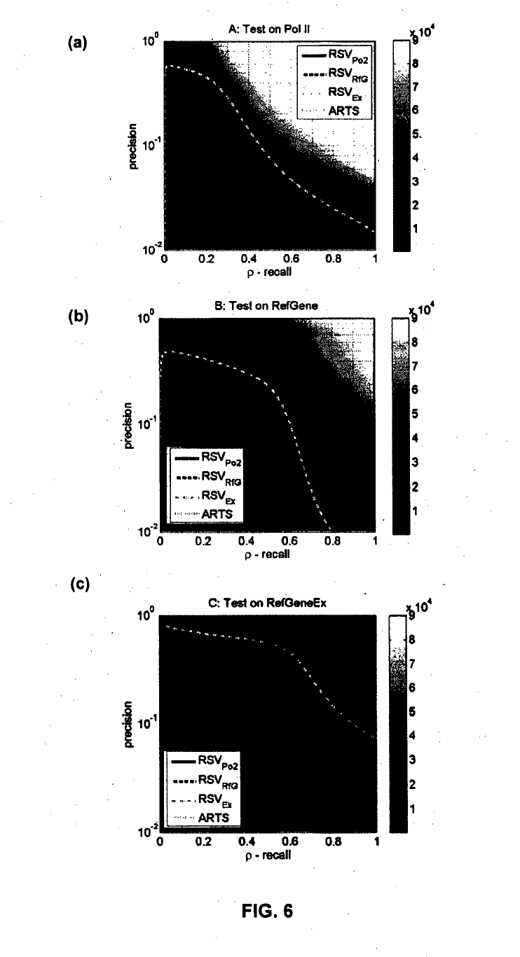

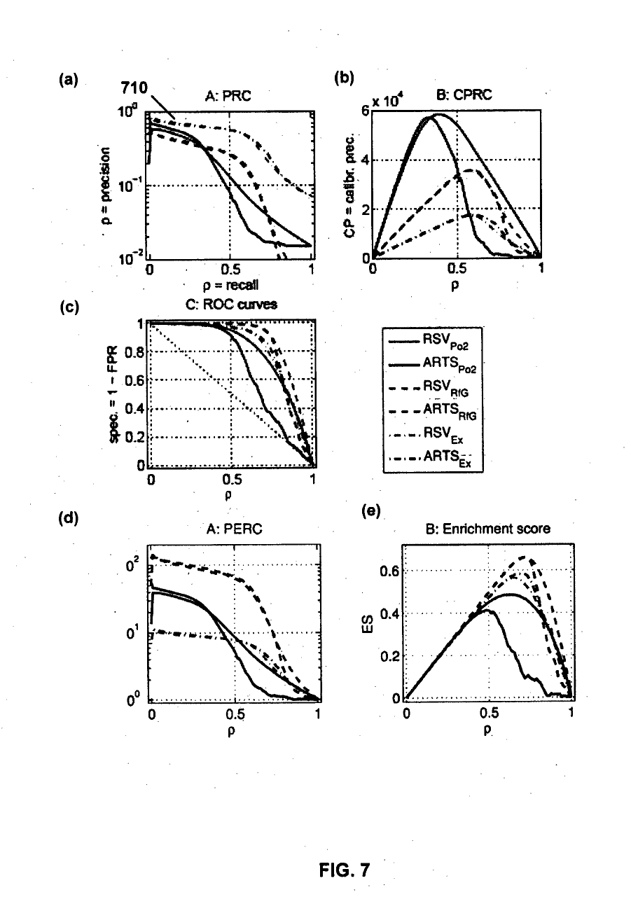

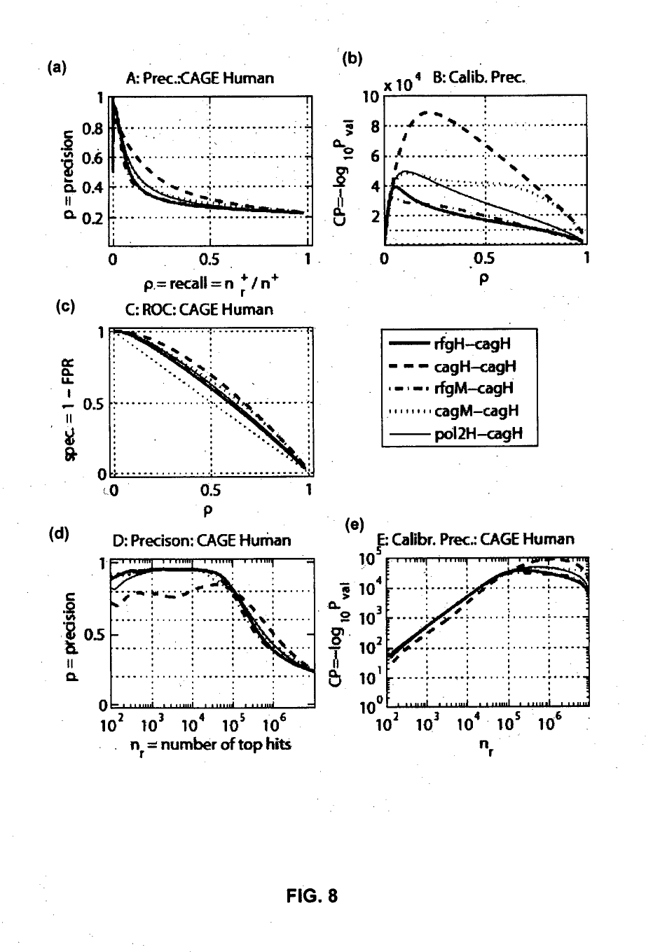

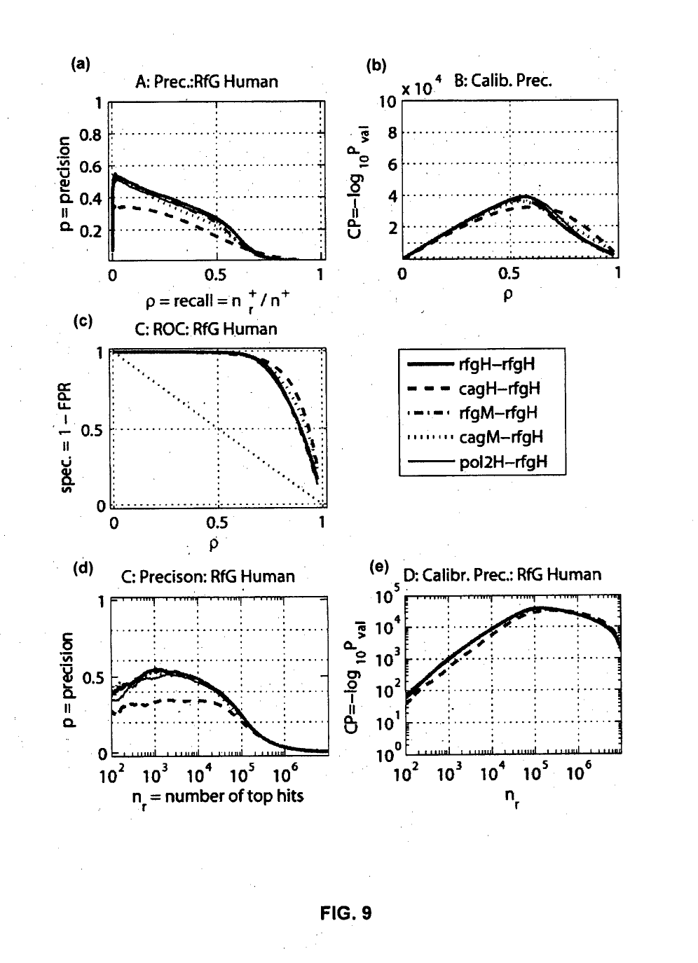

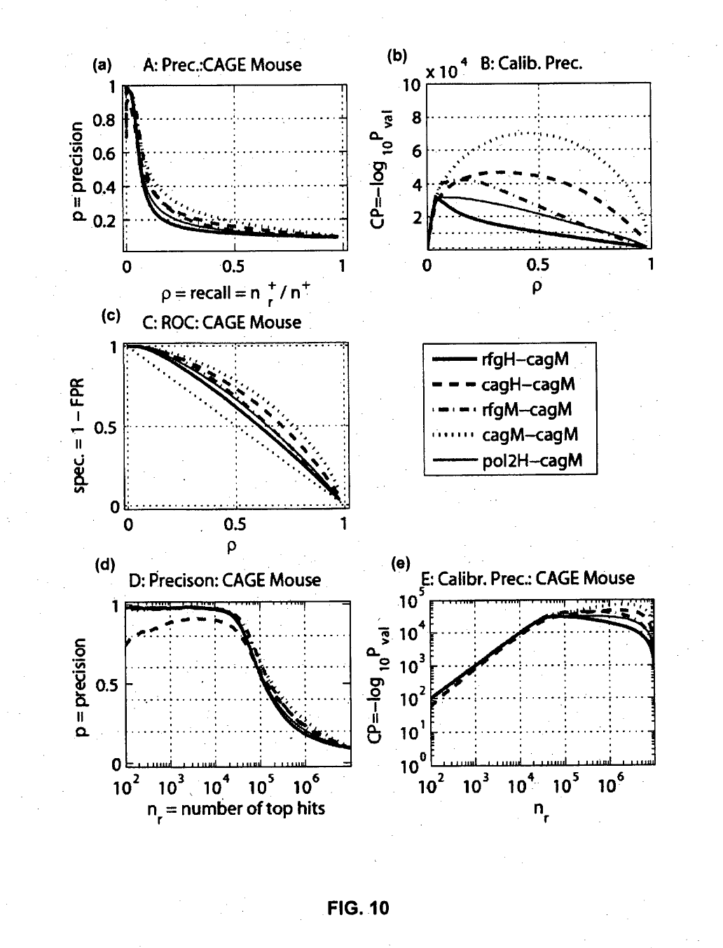

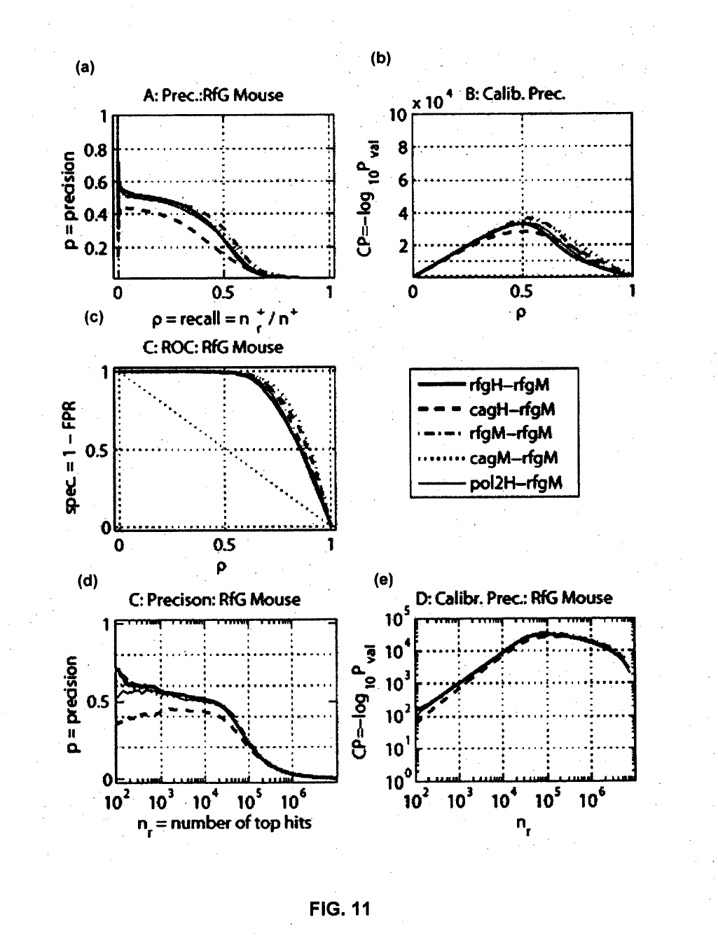

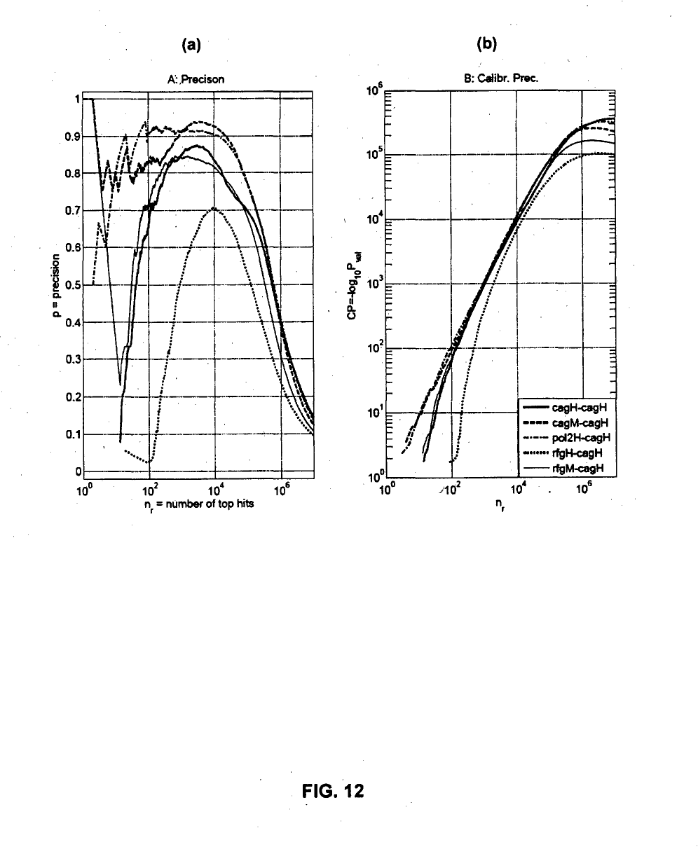

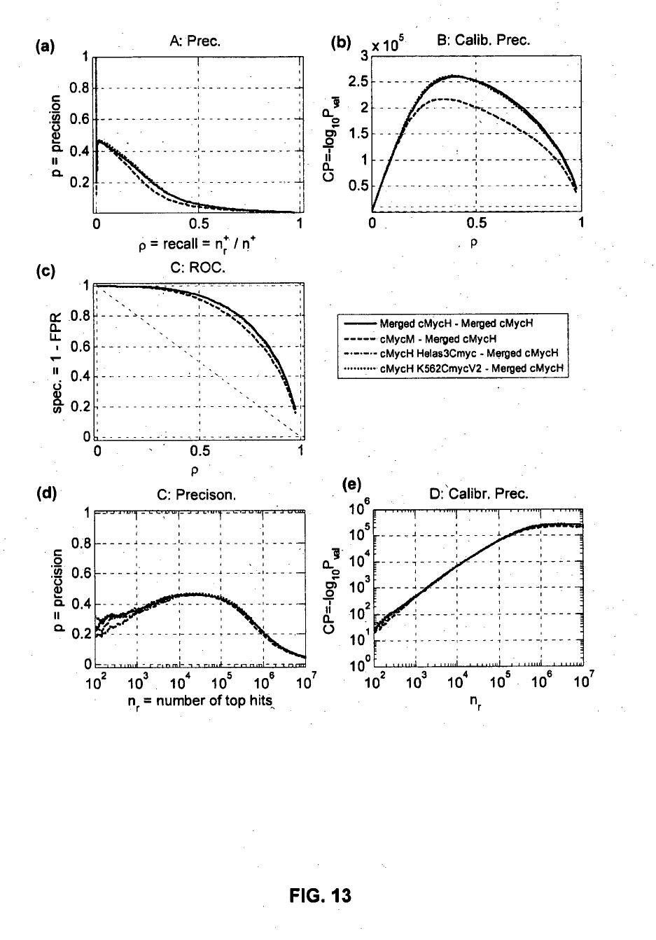

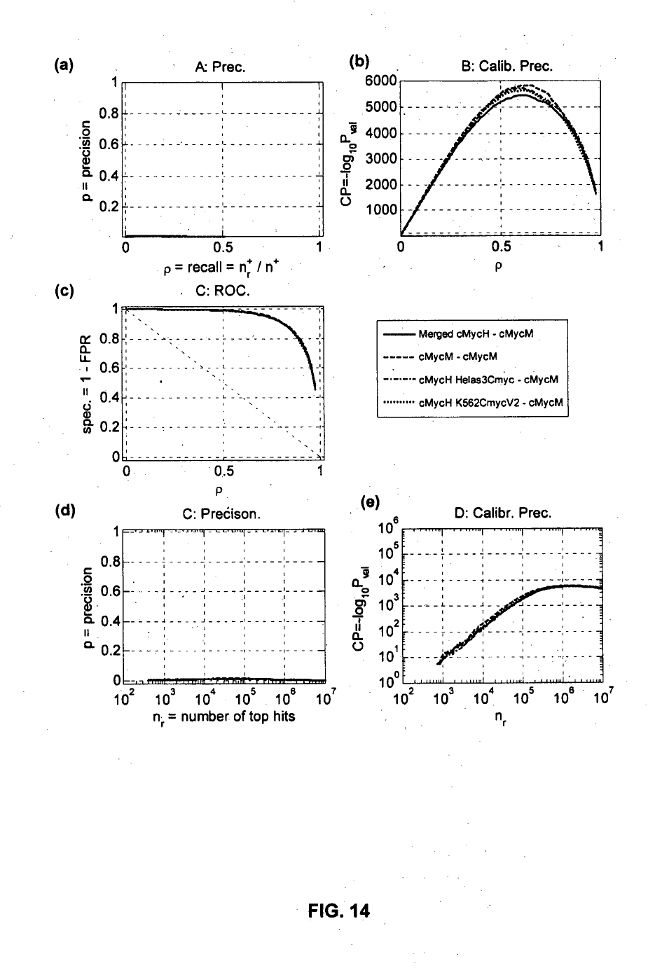

The area under ROC (auROC) is the area under an ROC curve, that is a plot of specificity spec(θ) versus recall ρ(θ); see FIG. 5(a). The receiver operating characteristic curve (ROC) and the area under it (auROC) (Hanley and McNeil, 1982), which can be used as a performance measure in machine learning, bioinformatics and statistics. Note that in this definition, the ROC curve is rotated 90° clockwise with respect to the typical ROC curve used by the machine learning community. The auROC has been shown to be equivalent to the probability of correctly ordering class pairs (Hanley and McNeil. 1982).

Both metrics, auROC and auPRC, are used in machine learning as almost equivalent concepts (see comment by Abeel et al. (2009) in section 2.4), though in the area of information retrieval the PRC is preferred. However, in the context of whole genome analysis they can provide dramatically different results, with the PRC and auPRC being the metrics of choice as the ROC and auROC are generally unreliable and possible completely uninformative. This corroborates the observations in Sonnenburg et al. (2006), however in their case they still choose to optimise auROC during model training while we optimise auPRC.

The PRC and ROC curve are typically used for comparing performance of classifiers on a fixed benchmark. However, when one evaluates a ChIP-Seq experiment, such as the Pol-II benchmark, there is no other classifier or dataset to compare performance against. Thus, a form of “calibration” is needed to evaluate the classifier performance in isolation. Consider two test datasets with radically different prior probability of positive examples:

n⁺/(n⁺+n⁻)=5% Case A:

n⁺/(n⁺+n⁻)=95% Case B:

If a uniformly random classifier is used, its expected precision at any recall level will be 5% in case A and 95% in case B.

Now, consider two non-random classifiers: f_{A} with precision p=10% on set A and f_{B} with precision p=99% on set B, both at recall p=20%. The question is which of them performs better, which is not straightforward to resolve. On one hand, the classifier f_{A} performs two times better than random guessing, while f_{B} performs only 1.04 times better than random guessing. Thus, in terms of the ratio to the expected performance of a random classifier, f_{A} performs far better than f_{B}. However, in case A the perfect classifier is capable of 100% precision, that is 10 times better than random guessing and 5 times better than f_{A}. In case B, the perfect classifier is capable of only 1.05 times better than random guessing. This is approximately what f_{B} is capable of, so f_{B} now seems stronger than f_{A}.

To resolve this problem, rather than analysing ratios we can ask a different question: what is the probability of observing better precision at given recall with random ordering of the data? The smaller such a probability, the better the performance of the classifier, hence it is convenient to consider −log₁₀ of those probabilities. We call this metric the calibrated precision, (CP), where better classifiers will result in higher values of CP. The plot of CP as a function of recall is referred to as the calibrated precision-recall curve (CPRC).

### Definition 6: Calibrated Precision

Calibrated precision CP(p, ρ) is defined as follows:

$$CP ( p , ρ ) := - {log}_{10} {\sum }_{x = 0}^{{n}_{r}^{-}} \frac{{n}^{+} ( \begin{matrix}{n}^{+} - 1 \\ {n}_{r}^{+} - 1\end{matrix} ) ( \begin{matrix}{n}^{-} \\ x\end{matrix} )}{( {n}_{r}^{+} + x ) ( \begin{matrix}n \\ {n}_{r}^{+} + x\end{matrix} )} , \qquad ( 6 )$$

where precision p=nᵣ⁺/(nᵣ⁺+nᵣ⁻) and recall ρ=nᵣ⁺/nᵣ⁺. This is −log₁₀ of the probability that for a uniform random ordering to the test examples, the n⁺ th positive example is preceded by ≦nᵣ⁻ negative examples. Calibrated precision may also be interpreted as the probability of observing an equal or better precision at a given recall with random ordering of the labels determined by the classifier 112.

As it is more convenient to convert CP curve into a single number for easy comparison, maximum calibrated precision is defined as:

max(CP):=max_{ρCP(}p(ρ),ρ).

To derive Eq. (6), the significance of an observed precision p(ρ) for a given recall ρ is compared with p_{NULL}(ρ), which is the precision for random sampling of the mixture of nᵣ⁺ and nᵣ⁻ positive and negative examples without replacement, until nᵣ⁺≧n⁺ρ successes (positive labels) are drawn. The latter random variable has a hypergeometric distribution, although in a slightly non-standard form as it is usually given for drawing a fixed number of nᵣ samples.

The scores allocated by a predictive model sort the test set of n=n⁺+n⁻ elements in a particular sequence. There are n! possible such sequences altogether, of which

$$( \begin{matrix}{n}^{+} - 1 \\ {n}_{r}^{+} - 1\end{matrix} ) ( \begin{matrix}{n}^{-} \\ {n}_{r}^{-}\end{matrix} ) ( {n}_{r} - 1 ) ! {n}^{+} ( n - {n}_{r} ) !$$

have exactly the same composition of nᵣ⁺ positive and nᵣ⁻ negative elements amongst the top nᵣ samples, assuming the nᵣth sample is fixed and has a positive label. The product of the first three factors above is the number of different (nᵣ−1)-sequences with the required positive/negative split, the fourth is the number of choices of the nᵣth element (out of n⁺ elements) and the fifth factor is the number of arrangements for the remaining n−nᵣ elements.

Dividing the above number by the total n!, of permutations of n elements gives the following expression for the probability

[symbol]

ₙ_{ᵣ}₊[Nᵣ⁻=nᵣ⁻]+f(nᵣ⁻),

where, following the usual convention, Nᵣ⁻ denotes the random variables with instantiations nᵣ⁻ and for x=0, 1, . . . , n⁻,

$$f ( x ) := \frac{{n}^{+} ( \begin{matrix}{n}^{+} - 1 \\ {n}_{r}^{+} - 1\end{matrix} ) ( \begin{matrix}{n}^{-} \\ x\end{matrix} )}{( {n}_{r}^{+} + x ) ( \begin{matrix}n \\ {n}_{r}^{+} + x\end{matrix} )} ;$$

For the observed recall ρ=nᵣ⁺/n⁺ (see Definition 1), the probability of observing the precision p:=nᵣ³⁰/nᵣ, (see Definition 2) or higher is:

$${P}_{val} := {ℙ}_{{n}_{r}^{+}} [ prec \geq p ] = {ℙ}_{{n}_{r}^{+}} [ {N}_{r}^{-} \leq {n}_{r}^{-} ] = {\sum }_{x = 0}^{{n}_{r}^{-}} f ( x )$$

where prec is an observed precision. Note that Pᵥₐₗ is precisely the p-value of interest to us, leading to the formula for the calibrated precision (CP) in Eq. (6) as follows:

$$\begin{matrix}CP ( p , ρ ) := - {log}_{10} {P}_{val} \\ = - {log}_{10} {\sum }_{x = 0}^{{n}_{r}^{-}} \frac{{n}^{+} ( \begin{matrix}{n}^{+} - 1 \\ {n}_{r}^{+} - 1\end{matrix} ) ( \begin{matrix}{n}^{-} \\ x\end{matrix} )}{( {n}_{r}^{+} + x ) ( \begin{matrix}n \\ {n}_{r}^{+} + x\end{matrix} )} , \\ = - {log}_{10} {\sum }_{x = 0}^{{n}_{r}^{-}} f ( x ) \\ = - {log}_{10} f ( {x}_{*} ) - ε ,\end{matrix}$$

$$where$$

$${x}_{*} := arg {max}_{0 \leq x \leq {n}_{r}^{-}} f ( x )$$

$$and \\ ⋃ \leq {log}_{10} {\sum }_{x = 0}^{{n}_{r}^{-}} \frac{f ( x )}{f ( {x}_{*} )} \leq {log}_{10} {n}_{r}^{-} \leq {log}_{10} n \leq 10$$

as the total number of choices n will not exceed the size of the genome, hence is ≦10¹⁰ in the cases of human or mouse genomes. Evaluation of −log₁₀ f(x_{*})−ε avoids the computation of the sum in Eq. (6) which can have millions of terms. The approximation error ε is negligible in practical situations encountered in this research where CP is of order of tens of thousands, hence practically ε/CP<<0.1%.

The maximum

$${x}_{*} := arg {max}_{0 \leq x \leq {n}_{r}^{-}} f ( x )$$

can be computed as follows. Consider the more general problem of finding

$${x}_{*} := arg {max}_{0 \leq x} f ( x ) .$$

Consider the inequality

$$ϕ ( x ) := \frac{f ( x + 1 )}{f ( x )} = \frac{( {n}_{r}^{+} + x ) ( {n}^{-} - x )}{( x + 1 ) ( n - {n}_{r}^{+} - x )} < 1.$$

This inequality is equivalent to the bound

$$x > \frac{{n}_{r}^{+} ( {n}^{-} + 1 ) - n}{{n}^{+} - 1} .$$

This implies that φ(x)≧1 for

$$x < {x}_{*}^{′} := ⌊ \frac{{n}_{r}^{+} ( {n}^{-} + 1 ) - n}{{n}^{+} - 1} ⌋ + 1 = ⌊ \frac{( {n}_{r}^{+} - 1 ) ( {n}^{-} + 1 )}{{n}^{+} - 1} ⌋$$

$$hence , \\ {x}_{*}^{′} = arg {max}_{0 \leq x} f ( x )$$

$$and$$

$${x}_{*} = min ( {n}_{r}^{-} , {x}_{*}^{′} ) .$$

A more constructive form can then be obtained:

$$CP ( p , p ) \approx - {log}_{10} \frac{{n}^{+} ( \begin{matrix}{n}^{+} - 1 \\ {n}_{r}^{+} - 1\end{matrix} ) ( \begin{matrix}{n}^{-} \\ {x}_{*}\end{matrix} )}{( {n}_{r}^{+} + {x}_{*} ) ( \begin{matrix}n \\ {n}_{r}^{+} + {x}_{*}\end{matrix} )}$$

As already mentioned, this approximation is generally very accurate in practice, with the relative error between 0 and −0.1%. In one implementation, binomial coefficient

$$( \begin{matrix}n \\ x\end{matrix} ) ,$$

or “n choose x”, can be approximated using Stirling's approximation, where log n!=n log n−n+0.5 log 2πn.

However, if necessary, a more precise approximation as follows can be used:

$$CP = - {log}_{10} f ( {x}_{+} ) {\sum }_{z = 0}^{{n}_{r}^{-}} \frac{f ( x )}{f ( {x}_{*} )} = - {log}_{10} f ( {x}_{*} ) - {log}_{10} [ 1 + {\sum }_{s = 1}^{{x}_{*}} {\prod }_{j = 0}^{s - 1} {ϕ}^{- 1} ( {x}_{*} - j ) + {\sum }_{s = 1}^{{n}_{r}^{-} {x}_{*}} {\prod }_{j = 0}^{i - j} ϕ ( {x}_{*} + j ) ] .$$

The sums above could contain tens of thousands or even millions of positive terms≦1, each can be easily evaluated recurrently. Those terms are monotonically decreasing, so summation can be terminated if a term's value is sufficiently low. For instance, if stop summation when a term has values below

$$\frac{\breve{δ}}{2 {n}_{\overline{r}} {log}_{10} e} ,$$

then we know that the resulting approximation will have an error between 0 and −δ.

In one implementation, the numerical computation of the sums and products above requires care as the numbers involved are large in practice, e.g. nᵣ³⁰˜10⁵ and n˜10⁷, hence a naive direct implementation might cause numerical under/over-flows. Indeed, the most significant Pᵥₐₗ computed in FIG. 5 are of order 10^{-90,000}, while standard IEEE double precision handles only numbers>10⁻³⁰⁸.

The above p-values, Pᵥₐₗ, are used in three different ways. Firstly, it is used for stratification of the precision-recall planes in FIG. 5. Secondly, given a family of particular PR curves of the form ρ→p(ρ), in FIG. 5(b), Pᵥₐₗ curves of the following form are plotted:

ρ [symbol] CP(p(ρ),ρ):=−log₁₀ [symbol] _{ρn}_{⁺}[prec≧p(ρ)],

where the right-hand-side is computed using the Pᵥₐₗ function defined above and assuming that the product ρn⁺ is rounded to the nearest integer. Thirdly, for each curve we also compute the area under it and list them in Table 3 below under the heading auCPRC. The area can be viewed as a measure of overall performance that is independent of any particular decision threshold.

Eq. (6) depends on values of n⁺ and n⁻, thus different results are expected for different values of those numbers even if their ratio is preserved. Indeed, if it is assumed that n=n⁺+n⁻=10³, then the respective values of the calibrated precision are CP_{A}=−3.74 and CP_{B}=−4.85. For n=10⁶, the results are CP_{A}=−904.3 and CP_{B}=−2069.2. The results are what one should expect intuitively considering dealing with datasets of size of hundreds is far easier than dealing with dataset of size of millions. More formally, in the latter case, although we have the same proportion of correct guesses as in the former case (that is, the same precision at the same recall level), the absolute number of correct guesses is proportionally higher. This is much harder, as by the central limit theorem of statistics, the average of larger number of repeated samplings has stronger tendency to converge to the mean, resulting in the variance inversely proportional to the number of trial.

Thus, for the larger datasets, the same size of deviation from the mean must result in a far smaller probability of occurrence. The above simple example vividly illustrates this principle, which is also clearly visible in the real-life test results explained further below with reference to FIG. 7(b) and Table 3. To enable easy comparisons, CPRC is converted into a single number. There are two options here: max(CP) which is the maximal rise of CPRC and auCPRC, which is the area under the CPRC. Note, the auCPRC is in line with areas under ROC and PRC, and can be interpreted as the expected value of the random variable CP on the space of positively labelled test examples.

Definition 7: Area Under CPRC

The area under CPRC (auCPRC) is defined as:

$$auCPRC := \frac{1}{{n}^{+}} {\sum }_{\vec{x} ε {x}_{+}} CP ( \vec{x} ) = {𝔼}_{\vec{x} ∈ {x}_{+}} [ CP ( \vec{x} ) ] \qquad ( 7 )$$

where n⁺ is the total number of positive examples, CP(\vec{x}):=CP(p(\vec{x}), ρ(\vec{x})) is the calibrated precision based on precision p(\vec{x}) and recall ρ(\vec{x}) and [symbol] ₊:={\vec{x}ᵢ|yᵢ=+1} is the subset of all (n⁺) positive examples.

The area under CPRC can be interpreted as the expected value of the random variable calibrated precision CP (\vec{x}) on the space of positively labelled test examples. More precisely, given a predictive model, f: [symbol] → [symbol] , where [symbol] ={\vec{x}₁, \vec{x}₂, . . . \vec{x}ₙ}ε [symbol] ^{m} is the set of all feature vectors with labels y₁, y₂, . . . , yₙε{−1, +1}. Let rank: [symbol] →{1, 2, . . . , n} be a (bijective) ranking of all n-test examples in agreements with the scoring function f, i.e. if f(\vec{x}ᵢ)>f(\vec{x}ⱼ), then rank (\vec{x}ᵢ)<rank (\vec{x}ⱼ). We assume here that rank is defined even in the case of draws with respect to the score f. Let [symbol] ₊:={\vec{x}ᵢ|yᵢ=+1} be a subset of all (n⁺) positive examples.

For any \vec{x}ε [symbol] ₊, the number of positive and negative examples are defined as:

n⁺(\vec{x}):=|{j|rank(\vec{x}ⱼ)≧rank(\vec{x})&yⱼ=+1}

n⁻(\vec{x}):=|{j|rank(\vec{x}ⱼ)≧rank(\vec{x})&yⱼ=−1}

and then:

$$ρ ( \vec{x} ) := \frac{{n}^{+} ( \vec{x} )}{{n}^{+}} , \\ p ( \vec{x} ) := \frac{{n}^{-} ( \vec{x} )}{{n}^{+} ( \vec{x} ) + {n}^{-} ( \vec{x} )} , \\ CP ( \vec{x} ) := CP ( p ( \vec{x} ) , ρ ( \vec{x} ) ) .$$

If we assume uniform distribution on the finite space [symbol] ₊, then the area under CPRC can be defined using the expectation in Eq. (7) above.

### PRC vs ROC

The whole genome scanning using NGS opens a new machine learning paradigm of learning and evaluating on extremely unbalanced datasets. Here, we are dealing with binary classification where the minority (target) class has a size often less than that of 1% of the majority class. This requires careful evaluation metrics of PRC and ROC curves and areas under them in particular and auROC and auPRC.

Referring now to FIG. 5, four performance metrics are compared using curves plotted against recall ρ: ROC in FIG. 5(a), PRC in FIG. 5(b), precision enrichment curves (PERC) in FIG. 5(c) and enrichment score in FIG. 5(d). FIG. 5(a) shows two simple, piecewise linear ROC curves with auROC=90%. The “elbow” points are at (0, 0.8) and (0.2, 1.0), respectively. Each curve is considered for three different class size ratios:
1. n⁺:n⁻=1:400 for A1 & B1;
2. n⁺:n⁻=1:40 for A2 & B2 and
3. n⁺:n⁻=1:4 for A3 & B3.

Ratio 1:400 roughly corresponds to a whole genome scan for TSS, while ratio 1:4 corresponds to the classical machine learning regime. Six corresponding PRCs are shown in FIG. 5(b). All three curves A1, A2 and A3 have auROC>90% with precision p=1 for recall ρ<0.9. Each of the three curves B1, B2 and B3 is different, with auPRC(B1)= 1/81≈1.2%, auPRC(B2)= 1/9≈11% and auPRC(B3)= 10/18≈62%, respectively.

Therefore, auPRC discriminates between the model of Class A with critical high specificity and the poorer models of Class B while auROC does not. However, auPRC for model A3, with reasonably balanced classes, is higher than for the NGS-type Case A1, with the significantly unbalanced classes and thus much “harder” to predict; see FIG. 5(b).

From the above example, PRC analysis is, in general, more suitable then ROC analysis for evaluation of datasets with highly unbalanced class sizes. However the PRC curve is inversely dependent on the minority or majority scale of such imbalance. This is a drawback if one intends to compare results involving different class size ratios, which may arise when comparing different experiments or methods.

The source of such discrepancies can be concluded from the definition of precision as follows (see Definition 4):

$$p ( θ ) := \frac{{n}_{r}^{+}}{{n}_{r}^{+} + {n}_{r}^{-}} = \frac{{n}_{r}^{+}}{{n}_{r}} .$$

If n⁺<<nᵣ⁻; then p(θ)≈nᵣ⁺/nᵣ⁻. Thus, if the number of minority class examples is increased uniformly by a factor K, then for the same recall threshold θ=θ(ρ) we expect K times more positive samples and approximately the same number of negative sample recalls. Hence, the precision will increase by factor K. A heuristic solution to this unwelcomed increase (scaling) is to take the ratio of precision to the prior probability of the minority class.

### Definition 8: Precision Enrichment Curve (PERC)

Precision enrichment pe(ρ) is defined as:

$$pe ( ρ ) := \frac{p ( ρ )}{{n}^{+} / {n}_{r}} = \frac{{F}_{r}^{+} ( ρ )}{{F}_{r} ( ρ )} ,$$

where Fᵣ⁺(ρ)=nᵣ⁺/n⁺ and Fᵣ(ρ):=nᵣ/n denote the cumulative distributions of recalls of the positive examples and of the mixture, respectively. See FIG. 5(c).

Note that nᵣ⁺/n⁺ is also the expected value of the conditional distribution of precision [symbol] [p|ρ]:= [symbol] [p|recall=ρ] for a given recall 0<ρ<1 for the distribution of uniform mixture of positive and negative examples. Indeed, under this assumption a randomly selected n×ρ sample is expected to contain n⁺×ρ positive samples. Thus,

$$𝔼 [ p \vert p ] \approx \frac{{n}^{+} \times ρ}{n \times ρ} = \frac{{n}^{+}}{n} .$$

Another argument can be based on the observation that the right-hand-side fraction above is the maximal likelihood estimator of the expectation of p|ρ with distribution characterised above. In summary, the precision enrichment has an appealing interpretation of gain in precision with respect to expectation of the precision for a uniform random sampling of the mixture. Alternatively it can be interpreted as the ratio of cumulative distributions and is thus linked to gene set enrichment analysis. It accounts for the ratio n⁺/n but still not for the values of n⁺ or n.

### Definition 9: Enrichment Score

The enrichment score for a given recall ρ is defined as (Subramanian et al., 2005):

ES(ρ):=Fᵣ⁺(ρ)−Fᵣ⁻(ρ),

where Fᵣ⁻ and Fᵣ⁺, respectively, denote cumulative distribution of the negative class and positive class, and the Kolmogorov-Smirnov statistic

$$KS := {max}_{ρ} \vert ES ( ρ ) \vert .$$

If the negative class size is much larger than the positive one, then Fᵣ⁻≈Fᵣ and p(ρ)≈Fᵣ⁺/Fᵣ⁻ is just the ratio rather than the difference of the two cumulative distributions. However, in the case of high class imbalance, the ES and KS-statistic are uninformative in terms of capturing performance under high precision settings. In this case,

$${F}_{r}^{+} ( ρ ) = ρ , \\ {F}_{r}^{-} ( ρ ) = ρ \frac{{n}^{+}}{{n}^{-}} ( \frac{1}{p} - 1 ) , \\ {F}_{r} ( ρ ) = ρ \frac{{n}^{+}}{n} \times \frac{1}{p} .$$

Thus, if n⁺<<n⁻, then both Fᵣ⁺ and Fᵣ are ≈0 whenever precision p>>n⁺/n≈0. Hence ES(ρ)≈ρ is monotonically increasing until the precision drops significantly, to the level of p≈n⁺/n.

For a further illustration, see FIG. 5(d) where all curves B1, B2 and B3 are collapsed to a single plot in spite significant differences in their precision, and FIG. 7(e) with all plots congregating on the diagonal for ρ<0.5. Those plots show that ES is not discriminating between different classifiers under the crucial high precision setting, which inevitably occurs for low recall (ρ<0.5).

An additional issue is the determination of statistical significance, which for the KS test is accomplished via a permutation test (Subramanian et al., 2005; Ackermann and Strimmer, 2009). Such a test is a computational challenge for NGS analysis as the datasets involved are ≈2 orders of magnitude larger than in the case of microarrays. Thus, a proper permutation test should involve two orders of magnitude more permutations, each followed by independent development of the predictive model, which is clearly infeasible.

However, it is feasible to associate with values of ES the significance in terms of p-values capturing the probability of observing larger values under a uniform random sampling of the mixture, i.e. along the lines developed for CPRC in Definition 6. However, we do not develop this here because such a p-value function on the (ρ, ES) plane is “unstable.” Namely, log Pᵥₐₗ diverges to ≈∞ along the diagonal ES=ρ. This diagonal is practically the locus of ES values for the critical initial segment (ρ<0.5) in FIG. 5(d). Hence in this area, even tiny differences of numerical imperfections lead to huge variations in significance, i.e., log Pᵥₐₗ, undermining the utility of such an extension.

### Example 1

### Training and Testing Using Human Data

In this example, the processing unit 110 evaluates the performance of the classifier 112 trained according to step 255 in FIG. 2 on the task of (in-silico) transcription start (TSS) prediction. In the following example, it is demonstrated that ChIP-Seq results can be used to develop robust classifiers by training on a small part of the annotated genome and then testing on the remainder, primarily for cross-checking the consistency of the ChIP-Seq results and also for novel genome annotation. As a proof of principle, Pol-II ChIP-Seq dataset is used.

The best-of-class in-silico TSS classifier ARTS serves as a specific baseline for accuracy assessment. Compared to ARTS, the following results demonstrate that the RSV classifier 112 requires simpler training and is more universal as it uses only a handful of features, k-mer frequencies in a linear fashion.

### 1(a) Datasets

In this example, different datasets are used for training and testing the classifiers, including whole genome scans, dataset similar to the benchmark tests used by Abeel et al. (2009) and Sonnenburg et al. (2006) and independent benchmark sets embedded in the software of Abeel et al. (2009).

### (i) Pol-II Dataset

This dataset is used as the main benchmark. The ChIP-Seq experimental data of Rozowsky et al. (2009) provides a list of 24,738 DNA ranges of putative Pol-II binding sites for the HeLa cell line. These ranges are defined by the start and end nucleotide. The lengths are varying between 1 and 74668 and have a median width of 925 bp.

Every 500 bp segment was given label 1 if overlapping a range of ChIP-Seq peak and −1 otherwise. This provides ≈160K positive and ≈11M negative labels.

### (Ii). RefGene Dataset

For this dataset, hg18 are used with RefGene annotations for transcribed DNA available through the UCSC Genome Browser (http://genome.ucsc.edu). It annotates ≈32K TSSs including alternative gene transcriptions. More specifically, if a 500 bp segment was overlapping the first base of the first exon it was labelled +1, and if not it was labelled −1. This creates n⁺=43K positive examples and n⁻=11M negative examples.

(iii) RefGeneEx Dataset

This is an adaptation of the previous dataset to the methodology proposed by Sonnenburg et al. (2006) and adopted by Abeel et al. (2009) in an attempt to generate more reliable negative labels. The difference is that all negative examples that do not overlap with at least one gene exon are discarded from the RefGene dataset. This gives n⁺=43K positive examples and n⁻=0.55M negative examples.

### 1(b) Classifiers

The predictions for ARTS were downloaded from a website (see http://www.fml.tuebingen.mpg.de/raetsch/suppl/arts) published by the authors of the algorithm (Sonnenburg et al., 2006). These predictions contain scores for every 50 bp segment aligned against hg17. The liftOver tool was used to shift the scores to hg18 (see http://hgdownload.cse.ucsc.edu/goldenPath/hg17/liftOver/). For the results shown in FIG. 6, FIG. 7, and Table 3, we took the maximum of the scores for all 50 bp segments contained within each 500 bp segment.

TABLE 1
Summary of Datasets

| | | | |
|---|---|---|---|
| Label Set | Pol-II | RefGene | RefGeneEx |

Training Sets for RSV (=intersections with Chr.22)

| | | | |
|---|---|---|---|
| n⁺ | 3.2K | 1.0K | 1.0K |
| n⁻ | 140K | 140K | 12K |

Test Sets

| | | | |
|---|---|---|---|
| n⁺ | 160K | 43K | 43K |
| n⁻ | 11M | 11M | 0.55M |
| n⁺/(n⁺ + n⁻) | 0.015 | 0.0039 | 0.072 |

The training datasets for RSV classifiers are summarised in Table 1. They are overlaps of the respective label sets with chromosome 22 only. In contrast, ARTS used carefully selected RefGene-annotated regions for hg16. This resulted in n⁺=8.5K and n⁻=85K examples for training, which contain roughly 2.5 to 8 times more positive examples than used to train the RSV models. Additionally, the negative examples for ARTS training were carefully chosen, while we have chosen all non-positive examples on. Chromosome 22 for RSV training, believing that the statistical noise will be mitigated by the robustness of the training algorithm.

### 1(c) Benchmark Against 17 Promoter Prediction Tools

Three RSV classifiers RSV_{Po2}, RSV_{RfG} and RSV_{Ex} are compared against 17 dedicated promoter prediction algorithms evaluated by Abeel et al. (2009) using the software provided by the authors. This software by Abeel et al. (2009) implements four different protocols:

Protocol 1A: This protocol is a bin-based validation using the CAGE dataset as a reference. This protocol uses non-overlapping 500 bp segments, with positive labels for segments that overlap the centre of the transcription start site and negative labels for all remaining segments.

Protocol 1B: This protocol is similar to 1A except it uses the RefGene set as reference instead of CAGE. The segments overlapping the start of gene are labelled +1, segments that overlap the gene but not the gene start are labelled −1 and the remaining segments are discarded.

Protocol 2A: This is a distance-based validation with the CAGE dataset as a reference. A prediction is deemed correct if it is within 500 bp from one of the 180,413 clusters obtained by grouping 4,874,272 CAGE tags (Abeel et al., 2009). For protocols 2A and 2B, the RSV prediction for every segment is associated with the center of the segment, which is obviously suboptimal.

Protocol 2B: This protocol is a modification of protocol 2A to “check the agreement between TSR [transcription start region] predictions and gene annotation . . . . [and] resembles the method used in the EGASP pilot-project (Bajic, 2006)”; see Abeel et al. (2009).

The results are summarised in Table 2 where the RSV classifier is compared with a subset of top performers reported by (Abeel et al., 2009, Table 2). Only one of the 17 dedicated algorithms evaluated in (Abeel et al., 2009), that is the supervised learning based ARTS, performs better than any of the three RSV classifiers in terms of overall promoter prediction program (PPP) score. The PPP score is the harmonic mean of four individual scores for tests 1A-2B introduced in (Abeel et al., 2009).

Also, only three additional algorithms out of 17 predictors evaluated by (Abeel et al., 2009) have shown performance better or equal to the RSV classifier on any individual test. The results demonstrate that, although the RSV classifier only uses raw DNA sequence and a small subset of the whole genome for RSV training, better or comparable results can be achieved. This is unexpected because the dedicated algorithms in (Abeel et al., 2009) use a lot of special information other than local raw DNA sequence and are developed using carefully selected positive and negative examples covering the whole genome.

TABLE 2
Results

| | | | | | |
|---|---|---|---|---|---|
| Name | 1A | 1B | 2A | 2B | PP score |

Our results using software of Abeel et al. (2009)

| | | | | | |
|---|---|---|---|---|---|
| RSV_{Po2} | 0.18 | 0.28 | 0.42 | 0.55 | 0.30 |
| RSV_{RfG} | 0.18 | 0.28 | 0.41 | 0.56 | 0.30 |
| RSV_{Ex} | 0.18 | 0.28 | 0.41 | 0.56 | 0.30 |

Results in Abeel et al. (2009) with performance ≧ any RSV

| | | | | | |
|---|---|---|---|---|---|
| ARTS | 0.19 | 0.36 | 0.47 | 0.64 | 0.34 |
| proSOM | 0.18 | 0.25 | 0.42 | 0.51 | 0.29 |
| EP3 | 0.18 | 0.23 | 0.42 | 0.51 | 0.28 |
| Eponine | 0.14 | 0.29 | 0.41 | 0.57 | 0.27 |

### 1(d) Self-Consistency Tests

Referring to FIG. 6, the PR curves for all four classifiers (RSV_{Po2}, RSV_{RfG}, RSV_{Ex} and ARTS) on three datasets are shown. Subplots A and B in FIGS. 6(a) and 6(b) show results for the genome wide tests on Pol-II (Rozowsky et al., 2009) and RefSeq database, respectively, while the third subplot, C in FIG. 6(c), uses the restricted dataset RefSeqEx (covering a ≈ 1/20 of the genome).

The PRC curves on each subplot are very close to each other, meaning that RSV_{Po2}, RSV_{RfG}, RSV_{Ex} and ARTS show very similar performance on all benchmarks despite being trained on different datasets. However, there are significant differences in those curves across different test datasets, with the curves for subplot C in FIG. 6(c) being much higher with visibly larger areas under them than for the other two cases, that is for the genome wide tests. However, this does not translate to statistical significance.

The background shading shows calibrated precision CP(p, ρ), values with the values in FIG. 6(a) and FIG. 6(b) clipped at maximum 9×10⁴ for better visualisation across all figures. More specifically, the background colour or shading shows stratification of the precision-recall plane according to statistical significance as represented by CP(p, ρ).

It is observed that curves in FIG. 6(a) run over much more significant regions (closer to the “white” area of maximum 9×10⁴) than the curves in FIG. 6(c), with plots in FIG. 6(b) falling in between. This is reflecting the simple fact that given a level of recall, in FIG. 6(a), it is much harder to achieve a particular level of precision while discriminating n⁺≈160K samples from the background n⁻≈11M than in FIG. 6(c), which deals with “only” one-quarter of positive samples n⁺≈43K embedded into the times smaller background of n⁻≈550K negative examples.

Note also that the most significant loci are different from the loci with the highest precision. In terms of FIG. 6(a) and the RSV_{Po2} classifier, it means that the precision p≈58.2% achieved at recall ρ=1% with CP(p, ρ)=2.1K is far less significant than p≈25% achieved at recall ρ-38%, which reaches a staggering CP(p, ρ)=58.4K.

To further quantify impact of the test data (that is, the differences between genome wide analysis and restriction to the exonic regions), the different benchmark sets and the three metrics PRC, ROC, and CPRC are plotted in FIG. 7. A comparison of three methods of evaluation for six different classifiers is shown: three versions of RSV as specified in Table 3 (RSV_{Po2}, RSV_{RfG} and RSV_{Ex}) and ARTS tested on three datasets (ARTS_{Po2}, ARTS_{RfG} and ARTS_{Ex}). The main difference between FIG. 6 and FIG. 7 is that, for clarity in the latter figure, we show for RSV classifiers the results for testing on the same dataset from which the training set was selected—i.e., no cross-dataset testing.

In FIG. 7(a), it is clearly observed that PRC for RefGeneEx (see 710 for RSV_{Ex} and ARTS_{Ex}) clearly dominates other curves. The curves for RSV_{Po2} and ARTS_{Po2} seem to be much poorer, which is supported by the ROC curves in FIG. 7(c). However, the plots of CPRC in FIG. 7(b) tell a completely different story. The differences shown by the shadings in FIG. 6 are now translated into the set of curves which clearly differentiate between the test benchmark sets, allocating higher significance to the more challenging benchmarks.

Some of those differences are also captured numerically in Table 3, where metrics auPRC, auCPRC and auROC denote areas under the PRC, CPRC and ROC curves in FIG. 7(a), 7(b) and 7(c), in the format RSV_{dataSet}/ARTS_{dataSet}, respectively. The maximum calibrated precision max(CP) is also shown with the corresponding values of precision and recall.

TABLE 3
Summary of performance curves for six classifiers in FIG. 7.

| Metric | Pol-II (Po2) | RefGene (RfG) | RefGeneEx (Ex) |
|---|---|---|---|
| auPRC | 0.22/0.22 | 0.23/0.22 | 0.47/0.46 |
| auCPRC | 34K/23K | 19K/18K | 9.0K/9.3K |
| auROC | 0.81/0.69 | 0.88/0.84 | 0.82/0.83 |
| max(CP) | 58.4K/57.2K | 36.0K/35.6K | 17.2K/17.5K |

arguments of max(CP)

| | | | |
|---|---|---|---|
| prec. | 0.25/0.31 | 0.20/0.20 | 0.51/0.48 |
| recall | 0.38/0.24 | 0.59/0.57 | 0.57/0.60 |
| nᵣ⁺ | 61K/54K | 24.3K/24.1K | 24.1K/25.3K |
| nᵣ | 243K/177K | 123K/120K | 47K/53K |
| n | 10.7M | 10.7M | 0.59M |

The most significant values are shown in boldface. The performance of RSV and ARTS are remarkably close, with ARTS slightly prevailing on the smallest testset RefGeneEx, which is the closest to the training set used for ARTS training, while RSV classifiers are better on the two genome-wide benchmarks. However, those differences are minor, the most striking is that all those classifiers are performing so well in spite of all differences in their development This should be viewed as a success of supervised learning which could robustly capture information hidden in the data (in a tiny fraction, 1/60th of the genome in the case of RSV).

It is observed that max(CP) is achieved by RSV_{Po2} for precision p=25% and recall ρ=38% positive samples out of n⁺=160K. This corresponds to compressing n⁺=61K of target patterns into the top-scored nᵣ⁻=23.4K samples out of n=10.7M. In comparison, the top CP results for ARTS on RefGeneEx data resulted in compression of nᵣ⁺=25.3K of positive samples into top nᵣ=47K out of total n=0.59M. Note that in the test on RefGene dataset, the results are more impressive then for RefGeneEx. In this case, roughly the same number of positive samples n⁺=23.4K was pushed into top nᵣ=123K out of n=10.6M, which is out of the dataset ≈20 times larger.

Note that FIG. 7(c) shows that ROC is not discriminating well between performance of different classifiers in the critical regimes of the highest precision, which inevitably occurs for low recall (ρ<0.5). Thus ROC and auROC have a limited utility in the genome wide scans with highly unbalanced class sizes. The same applies to the enrichment score of Subramanian et al. (2005) and consequently Kolmogorov-Smirnov statistic (see Definition 9). Note also that the better precision at low recall shown by ARTS_{Po2} compared to RSV_{Po2} in FIG. 6(a), FIG. 7(a), and FIG. 7(c) did not translate to significantly better CP in FIG. 7(b) as they were “soft gains.” The better performance of RSV_{Po2} for higher recall has turned out to be much more significant resulting in higher auCPRC in Table 3.

### 1(e) Discussions

Based on the above, it is demonstrated that the lack of information from empirical ChIP-Seq data, such as the directionality of the strands, does not prevent the development of accurate classifiers on-par with dedicated tools such as ARTS. The classifiers in the RSV method are created by a generic algorithm and not a TSS-prediction tuned procedure with customised problem-specific input features.

Compared with one or more embodiments of the method, ARTS is too specialised and overly complex. ARTS uses five different sophisticated kernels—i.e., custom developed techniques for feature extraction from DNA neighbourhood of ±1000 bp around the site of interest. This includes two spectrum kernels comparing the k-mer composition of DNA upstream (the promoter region) and down stream of the TSS, the complicated weighted degree kernel to evaluate the neighbouring DNA composition, and two kernels capturing the spatial DNA configuration (twisting angles and stacking energies). Disadvantageously, ARTS is very costly to train and run: it takes ≈350 CPU hours (Sonnenburg et al., 2006) to train and scan the whole genome. Furthermore, for training the labels are very carefully chosen and cross-checked in order to avoid misleading clues (Sonnenburg et al., 2006).

By contrast, the RSV method according to FIG. 2 and FIG. 3 is intended to be applied to novel and less studied DNA properties, with no assumption on the availability of prior knowledge. Consequently, the RSV model uses only standard and generic genomic features and all available labelled examples in the training set. It uses only a 137-dimensional, 4-mer based vector of frequencies in a single 500 bp segment, which is further simplified using feature selection to ≈80 dimensions. This approach is generic and the training and evaluation is accomplished within 4 CPU hours.

The performance of the exemplary RSV method is surprising and one may hypothesise about the reasons:
Robust training procedure: this includes the primal descent SVM training and using auPRC rather than auROC as the objective function for model selection;
Simple, low dimensional feature vector; and
Feature selection.

One curious point of note is the sharp decline in precision that can be observed as recall ρ→0 in FIG. 6 and FIG. 7(a). This can only be caused by the most confidently predicted samples being negatively labelled. One hypothesis is that these are in fact incorrectly labelled true positives. Support for this may be that the decline is not observable when using the exon-restricted negative examples in FIG. 6(c). Further testing against recent and more complete TSS data, the CAGE clusters in Example 2 below, confirms this hypothesis; see FIG. 8(d), FIG. 9(d), FIG. 10(d) and FIG. 11(d)

One of the most intriguing outcomes is the very good performance of the RSV_{Po2} classifier in the tests on the RefGene and RefGeneEx datasets and also on the benchmark of Abeel et al. (2009). After all, the RSV_{Po2} classifier was trained on data derived from broad ChIP-Seq peak ranges on chromosome 22 only. This ChIP-Seq data (Rozowsky et al., 2009) was derived from HeLa S3 cells (an immortalized cervical cancer-derived cell line) which differ from normal human cells. Those peaks should cover most of the TSS regions but, presumably, are also subjected to other confounding phenomena (e.g., Pol-II stalling sites (Gilchrist et al., 2008)). In spite of such confounding information, the training algorithm was capable of creating models distilling the positions of the carefully curated and reasonably localised TSS sites in RefGene.

As a proof of feasibility, it has been shown that the generic supervised learning method (RSV) is capable of learning and generalising from small subsets of the genome (chromosome 22). It is also shown that the RSV method successfully competes and often outperforms the baseline established by the TSS in-silico ARTS classifier on several datasets, including a recent Pol-II ENCODE ChIP-Seq dataset (Rozowsky et al., 2(09). Moreover, using the benchmark protocols of Abeel et al. (2009), it has been shown that the RSV classifier outperforms 16 other dedicated algorithms for TSS prediction.

For analysis and performance evaluation of highly class-imbalanced data typically encountered in genome-wide analysis, plain (PRC) and calibrated precision-recall curves (CPRC) can be used. Each can be converted to a single number summarising overall performance by computing the area under the curve. The popular ROC curves, auROC the area under ROC, enrichments scores (ES) and KS-statistics are generally uninformative for whole genome analysis as they are unable to discriminate between performance under the critical high precision setting.

It will be appreciated that, unlike a method tailored for specific application, a generic supervised learning algorithm is more flexible and adaptable, thereby more suitable for generic annotation extension and self validation of ChIP-Seq datasets. It will also be appreciated that the idea of self validation and developed metrics can be applied to any learning method apart from RSV, provided it is able to capture generic relationships between the sequence and the phenomenon of interest.

### Example 2

### Training and Testing Using Human and Mouse Data

### 2(a) Datasets

In this experiment, five different genome-wide annotation datasets described as follows and summarised in Table 4 are used. The first part of the Table 4 shows the number of positive marked segments and total number of segments for the training sets of human (chromosome 22) and mouse (chromosome 18) and the total number of segments. The second part shows the corresponding numbers for the whole genome and their ratio.

(i) Pol-II (pol2H).

This is used as the main benchmark, the same as Pol II dataset of Example 1. Recent ChIP-Seq experimental data of Rozowsky et al. (2009) provides a list of 24,738 DNA ranges of putative Pol-II binding sites for HeLa cell lines. These ranges are defined by the start and end nucleotide, the lengths are varying between 1 and 74668, and have a median width of 925 bp. Every 500 bp segment was given label 1 if overlapping a range of a ChIP-Seq peak and −1 otherwise. This provided 160K positive and ≈11M negative labels.

TABLE 4
Summary of datasets

Training Annotation

| | | | | | |
|---|---|---|---|---|---|
| Label Set | po2H | rfgH | cagH | rfgM | cagM |

Training Sets (=intersections with Chr.22/Chr. 18)

| | | | | | |
|---|---|---|---|---|---|
| n⁺ | 3.2K | 1.0K | 46K | 1.0K | 29K |
| n | 140K | 140K | 140K | 350K | 350K |

Test Sets

| | | | | | |
|---|---|---|---|---|---|
| n⁺ | 185K | 43K | 2.6M | 44K | 922K |
| n | 11M | 11M | 11M | 10M | 10M |
| n⁺/n | 0.016 | 0.0039 | 0.224 | 0.0043 | 0.090 |

(i) Pol-II (pol2H)

This is used as the main benchmark, the same as Pol II dataset of Example 1. Recent ChIP-Seq experimental data of Rozowsky et al. (2009) provides a list of 24,738 DNA ranges of putative Pol-II binding sites for HeLa cell lines. These ranges are defined by the start and end nucleotide, the lengths are varying between 1 and 74668, and have a median width of 925 bp. Every 500 bp segment was given label 1 if overlapping a range of a ChIP-Seq peak and −1 otherwise. This provided 160K positive and ≈11M negative labels.

(ii) RefGene Human (rfgH)

For this dataset, the same as RefGene dataset of Example 1, we have used hg18 with RefGene annotations for transcribed DNA available through the UCSC browser. It annotates ≈32K transcription start sites for genes, including alternative gene transcriptions. More specifically, if a 500 bp segment was overlapping the first base of the first exon it was labelled +1 and −1, otherwise. This created n⁺=43K positive and n⁻=11M negative examples.

(iii) CAGE Human (cagH)

The CAGE tags were extracted from the GFF-files which are available through the FANTOM 4 project (Kawaji et al., 2009) website. A segment which contains at least one tag with a score higher than zero was labelled +1 and −1 otherwise. Thus 1988630 tags were extracted out of 2651801, which gave 2.6M positive and 8.9M negative labels.

(iv) RefGene Mouse (rfgM)

This dataset was generated using the mm9 build with RefGene annotations which can be downloaded from the UCSC browser. The labelling was done the same way as its human equivalent. This created n⁺=43K positive and n⁻=11M negative examples.

(v) CAGE Mouse (cagM)

Using the FANTOM CAGE tags in the same way as for human generates 922K positive labelled segments of 698K tags with a greater than zero. This gives 9.3M negative examples.

### 2(b) Classifiers

The processing unit 110 trains three different RSV classifiers on human DNA data, RSV_{Po2}H, RSV_{RfgH}, and RSV_{cagH} using the methods described with reference to FIG. 2 and FIG. 3, and applies the trained classifiers on the above datasets. Two additional classifiers are trained on mouse data, RSV_{rfgM}, and RSV_{cagM}, each trained on an intersection of a corresponding dataset with chromosome 18, and applied to the same datasets. The training datasets for RSV classifiers are summarised in Table 4.

The results are shown in FIG. 8, where the trained RSV classifiers are applied on CAGE Human dataset; FIG. 9, where the trained RSV classifiers are applied on RefGene Human dataset; FIG. 10, where the trained RSV classifiers are applied on CAGE Mouse dataset; FIG. 11, where the trained RSV classifiers are applied on RefGene Mouse datasets; FIG. 9,

### 2(c) Results and Analysis

In this example, the five different classifiers or predictive models are trained and applied on five different test sets as discussed above. This subsection discusses the results of two tests: one against CAGE human genome and one against RefGene human genome annotations. The global performance of the classifiers is discussed below, while the local analysis of most significant peaks-regions is shifted to section 2(d). The performance curves for each of the five classifiers tested on human CAGE data in FIG. 8 and human RefGene in FIG. 9. Numerical summaries are presented in Table 5.

Let us analyse the precision recall curves (PRC), in FIG. 8(a) and FIG. 9(a), versus the ROC curves, in FIG. 9(c) and FIG. 9(c). The first striking observation is that in each of those subfigures all five curves are quite close to each other, with the lines representing the cagH model in precision-recall plots most different from the rest, though in opposite ways: better (higher) in CAGE test in FIG. 8 and worse (lower) in RefGene case in FIG. 9.

TABLE 5
Summary of performance in tests on human genome
(CAGE and RefGene), where metrics auPRC, auROC,
max(CP) as well as arguments of max(CP) are listed.

| Training Set | | | | |
|---|---|---|---|---|
| po2H | rfgH | cagH | rfgM | cagM |

Test on CAGE Human (cagH)

| auPRC | 34% | 32% | 38% | 31% | 34% |
|---|---|---|---|---|---|
| auROC | 59% | 57% | 63% | 57% | 61% |
| maxCP | 49K | 39K | 89K | 32K | 48K |
| | Arguments of maxCP | | | | |
| prec | 52% | 65% | 48% | 66% | 52% |
| recall | 10% | 5.4% | 21% | 4.2% | 10% |
| nᵣ | 510K | 210K | 1100K | 160K | 510K |
| nᵣ⁺ | 270K | 140K | 550K | 110K | 270K |

Test on RefGene Human (rfgH)

| auPRC | 23% | 24% | 17% | 23% | 21% |
|---|---|---|---|---|---|
| auROC | 87% | 87% | 90% | 87% | 89% |
| maxCP | 38K | 39K | 32K | 36K | 36K |
| | Arguments of maxCP | | | | |
| prec | 20% | 20% | 12% | 22% | 16% |
| recall | 57% | 57% | 57% | 52% | 57% |
| nᵣ | 130K | 130K | 230K | 110K | 170K |
| nᵣ⁺ | 26K | 26K | 26K | 24K | 26K |

The second observation is that the messages from the PRC and ROC plots are contradicting each other. The PRCs for CAGE in FIG. 8(a) are much higher than their counterparts for RefGene in FIG. 9(a). Indeed, Table 5 shows that area under the PRC, auPRC, for CAGE is ≈150%-200% higher than for RefGene tests. However, the corresponding ROC curves point in the opposite direction: the plots for CAGE in FIG. 8(c) follow very closely the diagonal, which represents the expected performance of a random classifier, while the ROC curves for RefGene in FIG. 9(c) are far from random. Indeed, in terms of the area under the ROC over a random classifier—i.e., auROC—50%—the CAGE curves show a small difference of between 7% and 13%, while the corresponding differences for RefGene test are more then 3 times higher and between 27% and 40%.

This discrepancy is due to the differences in prior probabilities of positive examples—i.e., the proportion n⁺/n, which according to Table 4 is over 22% for CAGE (cagH) and 55 times smaller for RefGene (RefGene). However, this explanation points to the major drawback of those two “classical” metrics: one needs to take into account the context, in which those two metrics are considered—i.e., additional information in the form of n⁺ and n values in order to sensibly interpret/calibrate those metrics. This is especially important if they are used for comparing vastly different test sets of size in millions, when direct inspections and contemplation of individual cases is vastly inadequate.

The above discussion of drawbacks of the PRC and ROC curves creates the right background for analysis in terms of the method of evaluating or quantifying the performance of classifiers in genome-wide analysis according to FIG. 4: the calibrated precision (CP). The plots of CP are shown in FIG. 8(b) & FIG. 9(b). The most noticeable is the differentiation between classifiers in test on cagH shown in FIG. 8(b). The relatively “tiny” differences between curves in FIG. 8(a) translate into the significantly greater differences in FIG. 8(b) once they are calibrated into p-values for random ordering.

Note the differences in the height of the plots, especially the curves for the RSV_{cagH} in FIG. 8(b) vs. FIG. 9(b). The elevation of the plots for CAGE test is fuelled by the size of the target set, 2.6M target cases embedded into the 11M of total data. The staggering minimal p-value of ≈1.0E-89,000 reflects the fact that RSV_{cagH} managed to push 550K of positive examples into the top 1.1M cases, which means it has achieves precision p=48% (>twice the background rate of 22%, Table 4) for recall of 21% (see Table 5). This indicates that the RSV_{cagH} model has extracted successfully some global non-trivial trends in the hundreds of thousands of sites for the CAGE tags. This is corroborated by the test on mouse genome, cagM, where this model achieved CP=47K, with recall 32% and precision 20%—i.e., the compression of the positive example to density>11 times higher than the background concentration of n⁺/n≈9%.

Although this RSV_{cagH} classifier is a clear winner on global scale, the other models are very impressive as well. Referring also to tests on CAGE Mouse cagM in FIG. 10, RSV_{cagM} the mouse version of RSV_{cagH}, has achieved the same precision of 20% as RSV_{cagH}, but with much higher recall, namely of 44% resulting in max (CP)=70K in FIG. 10(b). This means it managed to condense 410K out 922K of positive patterns into 2M of top scoring examples. While the both CAGE trained models, RSV_{cagH} and RSV_{cagM}, are impressive in dealing with annotation of bulk of the patterns, the models trained on refined RefGene annotations such as RSV_{rfgH} and RSV_{rfgM} are more impressive in achieving high precision though for a lower recall, in test on CAGE data.

For instance in test on cagH, RSV_{rfgH} and RSV_{rfgM} have achieved precision of 65% and 66% at recall of 5.4% and 4.2%, respectively, while both RSV_{Po2} H and RSV_{cagM}, trained on “unrefined” empirical data, obtained equivalent performance of precision 52% at recall 10%. Note the 10% recall correspond still the huge number of 510K of loci. This is far beyond capabilities of rigorous wet lab verification other than high throughput techniques and still far from an investigation of the peaks in start of the PRC curves in FIG. 8(a).

FIGS. 10(a) to (c) and FIGS. 11(a) to (c) show results of test on mouse data and are analogous to the FIGS. 8(a) to (c) and FIGS. 9(a) to (c) for test on human data. They show that models could be also ported from human to model organisms, i.e. mouse. There are some differences in details and shape of curves, but the similarity is overwhelming. Note that the results for models trained on CAGE mouse is better then for models trained on CAGE human, which can be explained by an easier, less constrained, experimentation and consequently a better quality of data for the model organism than human.

TABLE 5B
Summary of performance in tests on mouse genome
(CAGE and RefGene).

| Training Set | | | | |
|---|---|---|---|---|
| po2H | rfgH | cagH | rfgM | cagM |

Test on CAGE Mouse (cagM)

| auPRC | 24 | 25 | 19 | 27 | 26 |
|---|---|---|---|---|---|
| auROC | 84 | 84 | 86 | 85 | 88 |
| maxCP | 32K | 31K | 47K | 42K | 70K |
| | Argument of maxCP | | | | |
| prec | 55% | 68% | 20% | 30% | 20% |
| recall | 6.4% | 5% | 32% | 17% | 44% |
| nᵣ | 110K | 68K | 1500K | 520K | 2000K |
| nᵣ⁺ | 59K | 46K | 300K | 160K | 410K |

Test on RefGene Mouse (rfgM)

| maxCP | 34K | 33K | 28K | 36K | 35K |
|---|---|---|---|---|---|
| auPRC | 20 | 18 | 22 | 22 | 26 |
| auROC | 62 | 59 | 66 | 62 | 70 |
| | Argument of maxCP | | | | |
| prec | 22% | 27% | 13% | 28% | 25% |
| recall | 52% | 48% | 52% | 52% | 52% |
| nᵣ | 110K | 78K | 180K | 83K | 91K |
| nᵣ⁺ | 23K | 21K | 23K | 23K | 23K |

### 2(d) Analysis of Top Hits

The analysis of results for very low recall will now be analysed. To facilitate such an analysis we have prepared different version of plots in FIG. 8(a), FIG. 8(b), FIG. 9(a) and FIG. 9(b). More specifically, we plot the precision and calibrated precision but versus the number of recalled patterns, nᵣ using logarithmic scales in FIG. 8(d) and FIG. 8(e), as well as FIG. 9(d) and FIG. 9(e). The results are also summarised in Table 6.

TABLE 6
Summary statistics (%) for 10⁴ top hits in genome-wide tests on human
and on mouse (see bracketed numbers).
The columns are labelled by model (training set annotation).
Note that the majority of RefGene TSS is expected to be covered by
exonic segments, i.e. segments overlapping exons.

| Model (Training Set) | | | | |
|---|---|---|---|---|
| po2H | rfgH | cagH | rfgM | cagM |

Position

| | | | | | |
|---|---|---|---|---|---|
| exon | 66 | 69 | 51 | 68 | 70 |
| intron | 11 | 9 | 18 | 9 | 9 |
| intergenic | 23 | 22 | 31 | 23 | 21 |

Annotated Locations

| | | | | | |
|---|---|---|---|---|---|
| CAGE | 95 (97) | 95 (97) | 81 (90) | 95 (98) | 95 (98) |
| Ref Gene | 46 (50) | 48 (51) | 34 (43) | 48 (51) | 47 (50) |
| Pol-II | 59 | 60 | 45 | 59 | 58 |

Compared with FIG. 8(a), FIG. 8(b), FIG. 9(a) and FIG. 9(b), the results plotted in FIG. 8(d), FIG. 8(e), FIG. 9(d) and FIG. 9(e) immediately show changes to the peaks. We observe that in test on CAGE data for both mouse and human, for all models but RSV_{cagH}, for the ≈30K top-scoring cases, the precision is consistently above 95%. However, for tests on RefGene datasets the precision drops roughly to half. We conclude that among those top scores, roughly half has the RefGene annotation, while almost every one has a CAGE tag. This is corroborated by Table 6, where we have summarised the properties of systematic analysis top 10K scoring segments for each of our five models separately. In Table 6 we have also shown the statistics of position of top scoring tags with respect to the known genes against the human genome and partially mouse genome (see bracketed numbers in Table 6).

In FIG. 9(d) and FIG. 9(e), the RSV_{cagH} is achieving worse precision for nᵣ<10⁵ top cases than all the other models, even in test on CAGE Human data cagH in spite of being trained on a subset of it. However, RSV_{cagH} shows the best global performance, as we have discussed it in the previous subsection (see max(CP) in FIG. 8(e) & FIG. 9(e) and Table 5). We hypothesise that there must be some other CAGE tags which were not expressed in our data set. To test this hypothesis we should expand our cagH data set by inclusion CAGE tags for other tissue and other conditions.

FIG. 10(e) to (d) and FIG. 11(e) to (d) show results for test on Mouse genome analogous to test on human genome in FIG. 8(e) to (d) and FIG. 9(e) to (d). Again they show parallels between human and mouse genomes. Some additional details are described in Table 5B.

### 2(f) Discussions

Higher resolution transcriptome profiling has raised doubts to the capacity of in silico prediction of functional control elements in the genome, such as TSS (Cheng et al., 2005; Cloonan et al., 2008). However, we show here, that the most updated empirical annotations of TSS, RNA Pol-II ChIP-Seq and CAGE can effectively be substituted by improvement of the prediction algorithms. While this exercise is redundant to the cases where empirical evidence for TSS already exists, we do find many sites in the genome that are predicted but lack evidence in the empirical measurements. While these could be false positive hits, it is more likely that these are real TSS elements, active in specialised, uncharacterised cell type or conditions. Recording such annotations may become valuable to geneticists who find allelic variations or epigenetic signal in intergenic regions. Indeed, a lot of top hits are intergenic.

The evidence in support of these elements representing true TSS activity comes from the vast coverage of the existing annotations in our predicted TSS pool. Namely:
Many CAGE tags have transcriptions start sites the same as in RefGene genes,
50% of most significant hits are in CAGE but not in RefGene (compare FIG. 8(d) and FIG. 9(d)).

To further improve the algorithm we will swap the order between training and test datasets, use RNA Pol-II ChIP-Seq data to build predictive models for CAGE tags on par with refine RefGene annotation. There are a few potential future uses of the data:
Exploring RNA Poll-II elongation pauses, by seeking raw, imprecise, RNA Pol-II ChIP-Seq data, exclusive from CAGE and RefGene annotations.
Repeating the exercise across multiple organisms to better catergorise the evolutionary philogenic tree based on conservation of TSS elements. For example, we observe better prediction accuracy for mouse then for human. Prediction performance can be tested in both directions (human-mouse and vice-versa)
Better understanding of human TSS functional elements, beyond TATAA box and initiator, we are exploring simple local DNA features (4-mer frequencies in 500 BP segments) are on par with more advanced features used in ARTS.
Intergenic top segments without CAGE annotations are being characterised against high throughput deep RNA-Seq transcriptome to seek further evidence that these are functional TSS, probably becoming more active in specific conditions and cell types.

Looking at the biological annotation of the group of genes neighbouring these potential TSS may provide insight as to which conditions or cell types are currently not being represented in genome annotation. Further high resolution testing of coincidence of the region our algorithm predicted as TSS, with disease-associated SNPs is ongoing. In conclusion, at least one embodiment of the RSV method provides a good baseline in-silico tool for extending the empirical data obtained during phase I of the Encyclopedia of Non-COding DNA Elements (ENCODE), through to the rest of the genome, further to the TSS task we explored in this manuscript. Furthermore, our predicted TSS annotations merits consideration by the human ENCODE Genome Annotation Assessment Project (EGASP) (Guigo et al., 2006), and could improve our annotation of functional elements in the context of interpretation of genetic studies, such as genome wide disease-allelic associations.

### Example 3

### Smaller Window Size

The results described in Examples 1 and 2 were for the window of width w=500 bp. In this example we show results for classifiers RSV_{cagH}, RSV_{cagM}, RSV_{Po2} H, RSV_{RfgH} and RSV_{RfgM} applied on human CAGE data, for the window 10 times smaller, namely w=50 bp. The plots in FIGS. 12(a) and (b) are a 50 bp version of plots in FIGS. 8(d) and (e). We observe impressive precision of over 90% at top 10,000 labels forth models trained on mouse CAGE and empirical ChIP-Seq data. This precision matches the precision observed for the 500 bp window, however, the calibrated precision in FIG. 12(b) is higher than in FIG. 8(e), since now the total set of labels (segments) is 10 times larger, so the classification task is much harder.

### Example 4

### Annotation of Transcription Factor Binding Site

In this example, the classifier 112 is trained for annotation of transcription factor binding site. In experiments we have focused on an important oncogene, Myc (c-Myc) which encodes gene for a transcription factor that is believed to regulate expression of 15% of all genes (Gearhart et al, 2007) through binding on Enhancer Box sequences (E-boxes) and recruiting histone acetyltransferases (HATs). This means that in addition to its role as a classical transcription factor, Myc also functions to regulate global chromatin structure by regulating histone acetylation both in gene-rich regions and at sites far from any known gene (Cotterman et al, 2008).

A mutated version of Myc is found in many cancers which causes Myc to be persistently expressed. This leads to the unregulated expression of many genes some of which are involved in cell proliferation and results in the formation of cancer. A common translocation which involves Myc is t(8:14) is involved in the development of Burkitt's Lymphoma. A recent study demonstrated that temporary inhibition of Myc selectively kills mouse lung cancer cells, making it a potential cancer drug target (Soucek et al, 2008).

The following four human cell lines were downloaded from the website: http://hgdownload.cse.ucsc.edu/goldenPath/hg18/encodeDCC/wgEncodeYaleChIPseq/:
1. cMycH Helas3 Cmyc—a c-Myc human cell line.
2. cMycH K562 CmycV2—a c-Myc human cell line.
3. cMycH K562Ifna6hCmyc—a c-Myc human cell line.
4. cMycH K562Ifna30 Cmyc—a c-Myc human cell line.

For a more complete set of binding sites, the four datasets above are merged into a single dataset:
5. Merged cMycH.

For c-Myc mouse, the ChIP-Seq experiment available at website http://www.ncbi.nlm.nh.gov/geo/query/acc.cai?acc=GSM288356 is used:
6. cMycM—c-Myc mouse.

We have used 4 models trained for 4 label datasets described above, namely, (i) cMycH_MergedCellLine; (ii) cMycH_Helas3Cmyc; (iii) cMycH_K562CmycV2 and (iv) cMycM, respectively. For the first 3 human cell lines, we trained on chromosome 22; for the last, mouse model we trained on chromosome 18. In FIG. 13, we plot results for the four models tested on cMycH (Human) MergedCellLines and the corresponding results are in Table 7A. FIG. 14 and Table 7B show the results for the test on cMycM (Mouse).

TABLE 7A
Summary of performance in tests on Merged CellLine Human Dataset.

| | Training Set | | | |
|---|---|---|---|---|
| | Merged | | cMycH | cMycH |
| | cMycH | cMycM | Helas3Cmyc | K562CmycV2 |
| n⁺ | 812802 | 812802 | 812802 | 812802 |
| n⁻ | 97341997 | 97341997 | 97341997 | 97341997 |
| n⁺/n⁻ | 0.00828 | 0.00828 | 0.00828 | 0.00828 |
| auPRC | 13% | 12% | 14% | 14% |
| auROC | 1.8E+05 | 1.5E+05 | 1.8E+05 | 1.8E+05 |
| auCPRC | 83% | 81% | 83% | 83% |
| maxCP | 2.6E+05 | 2.2E+05 | 2.6E+05 | 2.6E+05 |
| | Argument of maxCP | | | |
| prec | 11% | 10% | 10% | 12% |
| recall | 39% | 34% | 40% | 38% |
| nᵣ⁺ | 3.2E+05 | 2.8E+05 | 3.2E+05 | 3.1E+05 |
| nᵣ⁻ | 2.6E+06 | 2.4E+06 | 2.8E+06 | 2.4E+06 |
| nᵣ | 2.9E+06 | 2.7E+06 | 3.1E+06 | 2.7E+06 |
| n | 9.8E+07 | 9.8E+07 | 9.8E+07 | 9.8E+07 |

We focus here on showing the results for the window w=50 bp in order to reinforce the message that the methodology of this invention is applicable of a high resolution annotations. The results are shown in FIGS. 13 and 14. Those two figures are somewhat analogous to the FIGS. 8 and 10, though the knowledge of binding sites for cMyc is far less complete than for RefGene or CAGE annotations. The observed accuracies for c-Myc are lower than for TSS prediction. However, they are far more precise than what can be obtained for use of standard position weight matrices (PWM) approaches (data not shown).

TABLE 7B
Summary of Performance in tests on cMycM Mouse Dataset (cMycM).

| | Training Set | | | |
|---|---|---|---|---|
| | | | cMycH | cMycH |
| | Merged cMycH | cMycM | Helas3Cmyc | K562CmycV2 |
| n⁺ | 7424 | 7424 | 7424 | 7424 |
| n⁻ | 86923096 | 86923096 | 86923096 | 86923096 |
| n⁺/n⁻ | 0.00009 | 0.00009 | 0.00009 | 0.00009 |
| auPRC | 0.49% | 0.61 | 0.52% | 0.53% |
| auROC | 3.70E+03 | 3.90E+03 | 3.90E+03 | 3.70E+03 |
| auCPRC | 93% | 93% | 93% | 93% |
| maxCP | 5.50E+03 | 5.80E+03 | 5.70E+03 | 5.60E+03 |
| | Argument of maxCP | | | |
| prec | 0.26% | 0.31% | 0.32% | 0.35% |
| recall | 60% | 60% | 59% | 56% |
| nᵣ⁺ | 4.5E+03 | 4.5E+03 | 4.4E+03 | 4.2E+03 |
| nᵣ⁻ | 1.7E+06 | 1.4E+06 | 1.4E+06 | 1.2E+06 |
| nᵣ | 1.7E+06 | 1.4E+06 | 1.4E+06 | 1.2E+06 |
| n | 8.7E+07 | 8.7E+07 | 8.7E+07 | 8.7E+07 |

Note that in test on cMyc human data in FIG. 13 the model trained on mouse data (“cMycM—Merged cMycH”) performs comparable to the models trained on human data. However, in FIGS. 14(a) and (d) we observe a collapse of precision curves. This is caused by the extreme class imbalance in the cMycM data, where this ChIP_Seq dataset has approximately 3000 peak ranges and the positive labels consist a fraction of 0.009% of the data; see Table 7B. This causes that any fraction top fraction of recalled labels is “swamped” by the negative labels and precision is always close to 0. However, the calibrated precision and ROC curves in FIGS. 14(b) and (c), respectively, clearly show that this is too pessimistic assessment. This can be argued as a strong endorsement for the calibrated precision as a versatile metric a of classifier performance in the context considered here, especially that the ROC curves have their own deficiencies as well.

### Variations

It will be appreciated by persons skilled in the art that numerous variations and/or modifications may be made to the invention as shown in the specific embodiments without departing from the scope of the invention as broadly described. The present embodiments are, therefore, to be considered in all respects as illustrative and not restrictive.

For example, the method described with reference to FIG. 2 and FIG. 3 can be applied to annotation of ribonucleic acid (RNA) sequences. In this case, an, RNA sequence \vec{s} segmented into segments or tiles \vec{x}ᵢ can be defined as follows:

\vec{s}ε{a,g,u,c}ⁿ and \vec{x}ᵢε{a,c,u,t}^{w}

where n is the length of the sequence \vec{x}, w<n is the window size or length of the segment and each nucleotide in the sequence \vec{x} or tile \vec{x}ᵢ is either adenine (a), guanine (g), uracil (u) or cytosine (c). Similarly, one or more features \vec{φ}(\vec{x}ᵢ) can be extracted from the RNA tile \vec{x}ᵢ to train a classifier with the following predictive function:

f(\vec{x}ᵢ):= [symbol] \vec{φ}(\vec{x}ᵢ),\vec{β}

[symbol]

where \vec{x}ᵢ is the ith segment, \vec{φ}(\vec{x}ᵢ) is a feature vector and \vec{β} is a weight or coefficient vector with weights corresponding to each feature in the feature vector. In this case, the classifier 112 may be trained to annotate 5′ untranslated regions (UTRs); 3′ UTRs; and intronic sequences which would control processes such as transcription elongation, alternative splicing, RNA export, sub-cellular localisation, RNA degradation and translation efficiency. An example of such regulatory mechanism is micro-RNAs which bind to 3′ UTRs.

It should also be understood that, unless specifically stated otherwise as apparent from the following discussion, it is appreciated that throughout the description, discussions utilizing terms such as “receiving”, “processing”, “retrieving”, “selecting”, “calculating”, “determining”, “displaying” or the like, refer to the action and processes of a computer system, or similar electronic computing device, that processes and transforms data represented as physical (electronic) quantities within the computer system's registers and memories into other data similarly represented as physical quantities within the computer system memories or registers or other such information storage, transmission or display devices. The processing unit 110 and classifier 112 can be implemented as hardware, software or a combination of both.

It should also be understood that the methods and systems described might be implemented on many different types of processing devices by computer program or program code comprising program instructions that are executable by one or more processors. The software program instructions may include source code, object code, machine code or any other stored data that is operable to cause a processing system to perform the methods described. The methods and systems may be provided on any suitable computer readable media. Suitable computer readable media may include volatile (e.g. RAM) and/or non-volatile (e.g. ROM, disk) memory, carrier waves and transmission media (e.g. copper wire, coaxial cable, fibre optic media). Exemplary carrier waves may take the form of electrical, electromagnetic or optical signals conveying digital data streams along a local network or a publically accessible network such as the Internet.

It should also be understood that computer components, processing units, engines, software modules, functions and data structures described herein may be connected directly or indirectly to each other in order to allow any data flow required for their operations. It is also noted that software instructions or module can be implemented using various of methods. For example, a subroutine unit of code, a software function, an object in an object-oriented programming environment, an applet, a computer script, computer code or firmware can be used. The software components and/or functionality may be located on a single device or distributed over multiple devices depending on the application.

Reference in the specification to “one embodiment” or “an embodiment” of the present invention means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment. Unless the context clearly requires otherwise, words using singular or plural number also include the plural or singular number respectively.

### REFERENCES

Abeel, T., de Peer, Y. V., and Saeys, Y. (2009). Toward a gold standard for promoter prediction evaluation. Bioinformatics, 25, i313-i320.
Abeel, T., Saeys, Y., Rouze, P., and de Peer, Y. V. (2008). Pro-SOM: core promoter prediction based on unsupervised clustering of DNA physical profiles. Bioinformatics.
Abeel, T. e. a. (2008). Generic eukaryotic core promoter prediction using structural features of DNA. Genome Res., 18, 310323.
Bajic, V. e. a. (2006). Performance assessment of promoter predictions on ENCODE regions in the EGASP experiment. Genome Biol., 7(Suppl 1), S3.1S3.13.
Bedo, J., Macintyre, G., Haviv, I., and Kowalczyk, A. (2009). Simple svm based whole-genome segmentation. Nature Precedings.
Bedo, J., Sanderson, C. and Kowalczyk, A. (2006). An efficient alternative to SVM based recursive feature elimination with applications in natural language processing and bioinformatics. 19th Australian Joint Conference on Artificial Intelligence.
Baggerly, K. A., Deng L., Morris J. S., Aldaz C. M.: Differential expression in SAGE: accounting for normal between-library variation. Bioinformatics 19(12) (2003) 1477-1483.
Cloonan, N., Forrest, A. R., Kolle, G., Gardiner, B. B., Faulkner, G. J., Brown, M. K., Taylor, D. F., Steptoe, A. L., Wani, S., Bethel, G., Robertson, A. J., Perkins, A. C., Bruce, S. J., Lee, C. C., Ranade, S. S., Peckham, H. E., Manning, J. M., McKernan, K. J., and Grimmond, S. M. (2008). Stem cell transcriptome profiling via massive-scale mrna sequencing. Nature methods, 5, 613-619.
Down, T. and Hubbard, T. (2002). Computational detection and location of transcription start sites in mammalian genomic DNA. Genome Res., 12, 458461.
Gilchrist, D. A., Nechaev, S., Lee, C., Ghosh, S. K. B., Collins, J. B., Li, L., Gilmour, D. S., and Adelman, K. (2008). NELF-mediated stalling of Pol II can enhance gene expression by blocking promoter-proximal nucleosome assembly. Genes & Development, 22, 1921-1933.
Hanley, J. A. and McNeil, B. J. (1982). The meaning and use of the area under a receiver operating characteristic (ROC) curve. Radiology, 143, 29-36.
Hartman, S., Bertone, P., Nath; A., Royce, T., Gerstein, M., Weissman, S., and Snyder, M. (2005). Global changes in STAT target selection and transcription regulation upon interferon treatments, Genes & Dev., 19, 29532968.
Kowalczyk, A., Bedo, J., Conway, T., and Beresford-Smith, B. (2010). Poisson Margin Test for Normalisation Free Significance Analysis of NGS Data.
Rozowsky, J., Euskirchen, G., Auerbach, R., Zhang, Z., Gibson, T., Bjornson, R., Carriero, N., Snyder, M., and Gerstein, M. (2009), PeakSeq enables systematic scoring of ChIP-seq experiments relative to controls. Nature Biotechnology, 27, 6675.
Sonnenburg, S., Zien, A., and Ratsch, G. (2006). Arts: accurate recognition of transcription starts in human. Bioinformatics, 22, e423-e480.
Subramanian, A., Tamayo, P., Mootha, V. K., Mukherjee, S., Ebert, B. L., Gillette, M. A., Paulovich, A., Pomeroy, S. L., Golub, T. R., Lander, E. S., and Mesirov, J. P. (2005). Gene set enrichment analysis: A knowledge-based approach for interpreting genomewide expression profiles. Proceedings of the National Academy of Sciences of the United States of America, 102, 15545-15550.
Wang, X., Xuan, Z., Zhao, X., and Li, M., Y. and Zhang (2008). High-resolution human core-promoter prediction with CoreBoost HM. Genome Research, 19, 266-275.
Zhao, X., Xuan, Z., and Zhao, M. (2007). Boosting with stumps for predicting transcription start sites. Genome Biology, 8:R17.
Nix, D, Courdy, S, Boucher, K: Empirical methods for controlling false positives and estimating confidence in chip-seq peaks. BMC Bioinformatics 9 (2008) 523.
Robertson, G., Hirst, M., Bainbridge, M., Bilenky, M., Zhao, Y., Zeng, T., Euskirchen, G., Bernier, B., Varhol, R., Delaney, A., et al.: Genome-wide profiles of STAT1 DNA association using chromatin immunoprecipitation and massively parallel sequencing. Nature Methods 4 (2007) 651-657
Kowalczyk, A.: Some Formal Results for Significance of Short Read Concentrations. (2009) http://www.genomics.csse.unimelb.edu.au/shortreadtheory.
Baggerly, K. A., Deng, L., Morris, J. S., Aldaz, C. M.: Differential expression in SAGE: accounting for normal between-library variation. Bioinformatics 19(12) (2003) 1477-1483.
Robinson, M., Smyth, G.: Moderated statistical tests for assessing differences in tag abundance. Bioinformatics 23(21) (2007) 2881-2887.
Bloushtain-Qimron, N., Yao, J., Snyder, E.: Cell type-specific DNA methylation patterns in the human breast. PANS 105 (2008) 1407614081.
Zang, C., Schones, D. E., Zeng, C., Cui, K., Zhao, K., Peng, W.: A clustering approach for identification of enriched domains from histone modification ChIP-Seq data. Bioinformatics 25(15) (2009) 1952-1958
Keeping, E.: Introduction to Statistical Inference. Dover, ISBN 0-486-68502-0 (1995) Reprint of 1962 edition by D. Van Nostrand Co., Princeton, N.J.
Zhang, Y., Liu, T., Meyer, C., Eeckhoute, J., Johnson, D., Bernstein, B., Nussbaum, C., Myers, R., Brown, M., Li, W., Liu, X. S.: Model-based analysis of chip-seq (macs). Genome Biology 9(9) (2008) R137+
Ji, H., Jiang, H., Ma, W., Johnson, D., Myers, R., Wong, W.: An integrated software system for analyzing ChIP-chip and ChIP-seq data. Nature Biotechnology 26 (2008) 1293-1300.
Gearhart J, Pashos E E, Prasad M K (2007). Pluripotency Redeux—advances in stem-cell research, N Engl J Med 357(15):1469 Free full text
Cotterman R, Jin V X, Krig S R, Lemen J M, Wey A, Farnham P J, Knoepfler P S. (2008). “N-Myc regulates a widespread euchromatic program in the human genome partially independent of its role as a classical transcription factor.”. Cancer Res. 68 (23): 9654-62. doi:10.1158/0008-5472.CAN-08-1961. PMID 19047142.
Soucek, Laura; Jonathan Whitfield, Carla P. Martins, Andrew J. Finch, Daniel J. Murphy, Nicole M. Sodir, Anthony N. Karnezis, Lamoma Brown Swigart, Sergio Nasi & Gerard I. Evan (2008-10-02). “Modelling Myc inhibition as a cancer therapy”. Nature (London, UK: Nature Publishing Group) 455 (7213): 679-683. doi:10.1038/nature07260. PMID 18716624. http://www.nature.com/nature/iournal/v455/n7213/abs/nature07260.html. Retrieved 2008-10-14.

1. A computer-implemented method for annotation of a biological sequence, comprising a processor:
applying a classifier to determine a label for a first segment of a first biological sequence of a first species based on an estimated relationship between second segments in a training set and known labels of the second segments in the training set,
wherein the classifier is trained using the training set to estimate the relationship, and the second segments are of a second biological sequence of a second species that is different to, or a variant of, the first species.

2. The method of claim 1, further comprising:
extracting one or more features from the first segment, wherein the one or more features are also extractable from the second segments in the training set; and
determining the label for the first segment based on the estimated relationship and the one or more extracted features.

3. The method of claim 2, wherein the one or more features include one or more of the following:
an occurrence frequency of a k-mer in the segment;
a position weight matrix (PWM) score histogram of the segment;
empirical data or estimation of transcription factor binding affinity of a transcription factor in the segment;
a non-linear transformation of a set or a subset of features; and
occurrence of a base pair in the segment.

4. The method of claim 2, wherein the estimated relationship is represented by a set of weights corresponding to the one or more extracted features.

5. The method of claim 1, wherein the first species is human and the second species is non-human, or vice versa.

6. The method of claim 1, wherein the first species is a healthy cell of an organism, and the second species is a diseased cell that has diverged from its original germline sequence present in the first species, or vice versa.

7. The method of claim 1, wherein the first species is a diseased tissue sample of a first patient, and the second species is a diseased tissue sample of a second patient who is distinct from the first patient in its clinical presentation, or vice versa.

8. The method of claim 1, wherein the first or second biological sequence is a genome and the first or second segments are genome segments.

9. The method of claim 1, wherein the first or second biological sequence is an RNA sequence and the first or second segments are RNA segments.

10. The method of claim 8, wherein the label of each segment represents whether the segment is a transcription start site (TSS).

11. The method of claim 8, wherein the label of each segment represents one of the following:
whether the segment is a transcription factor binding site (TFBS);
a relationship between the segment and one or more epigenetic changes;
a relationship between the segment and one or more somatic mutations;
an overlap with a peak range in a reference biological sequence.
whether the segment is a 5′ untranslated region (UTR); and
whether the segment is a 3′ untranslated region (UTR).

12. The method of claim 1, further comprising:
applying the classifier to determine a label for third segments,
wherein the third segments are of the second biological sequence of the second species, but not in the training set.

13. The method of claim 1, further comprising, prior to applying the classifier, training the classifier using the training set to estimate the relationship between the second segments and known labels of the second segments.

14. The method of claim 13, wherein the estimated relationship is determined by optimising an objective function parameterised by a set of weights and one or more features extracted from the second segments in the training set.

15. The method of claim 14, wherein optimising the objective function is performed iteratively with feature elimination in each iteration until the number of features satisfies a predetermined threshold.

16. The method of claim 15, wherein feature elimination comprises ranking the extracted features based on a set of weights, and eliminating one or more of the extracted features that are associated with the smallest weight.

17. The method of claim 1, wherein the classifier is a support vector machine classifier.

18. The method of claim 1, further comprising evaluating performance of the classifier by estimating the probability of observing an equal or better precision at a given recall with random ordering of labels determined by the classifier.

19. A computer program comprising machine-executable instructions to cause a computer system to implement a method for annotation of a biological sequence comprising:
applying a classifier to determine a label for a first segment of a first biological sequence of a first species based on an estimated relationship between second segments in a training set and known labels of the second segments in the training set,
wherein the classifier is trained using the training set to estimate the relationship, and the second segments are of a second biological sequence of a second species that is different to, or a variant of, the first species.

20. A computer system for annotation of a biological sequence, the system comprising:
a processing unit operable to apply a classifier determine a label for a first segment of a first biological sequence of a first species based on an estimated relationship between second segments in a training set and known labels associated with the second segments in the training set,
wherein the classifier is trained using the training set to estimate the relationship, and the second segments are of a second biological sequence of a second species that is different to, or a variant of, the first species.
